(19) United States
(12) Patent Application Publication
(10) Pub. No.: US 2026/0145941 A1
(43) Pub. Date: May 28, 2026

(54) METHODS AND SYSTEMS FOR DIRECT RECYCLING AND UPCYCLING OF PHOSPHATE-BASED CATHODE ACTIVE MATERIALS

(71) Applicant: Princeton NuEnergy Inc., Monmouth Junction, NJ (US)

(72) Inventors: Jinyun LIAO, Newtown, PA (US); Hao LIU, Fremont, CA (US); Tyler Edward MCGIVERN-JIMENEZ, West Windsor, NJ (US); Chao YAN, Princeton, NJ (US); Xiaofang YANG, Ambler, PA (US)

(21) Appl. No.: 19/394,742

(22) Filed: Nov. 19, 2025

Related U.S. Application Data
(60) Provisional application No. 63/725,113, filed on Nov. 26, 2024.

(51) Int. Cl. C01B 25/45; B01J 2/04; H01M 10/54

(52) U.S. Cl. CPC C01B 25/45; B01J 2/04; H01M 10/54; C01P 2002/54; C01P 2002/72; C01P 2004/03; C01P 2004/61; C01P 2004/62; C01P 2006/12

(57) ABSTRACT

Some embodiments are directed to systems and methods for direct recycling and upcycling of cathode materials. In one aspect, a method for direct recycling of cathode materials includes obtaining spent phosphate-containing cathode active materials (CAM). The method includes purifying the spent phosphate-containing CAM to obtain purified phosphate-containing CAM. The method also includes regenerating the purified phosphate-containing CAM to obtain regenerated phosphate-containing CAM. In some embodiments, the regenerating includes preserving a morphology and chemical composition of the purified phosphate-containing CAM. In some embodiments, the regenerating includes varying either one or both of the morphology and chemical composition of the purified phosphate-containing CAM.

### RELATED APPLICATIONS

This application claims priority to U.S. Provisional Patent Application No. 63/725,113, filed Nov. 26, 2024, titled “Methods and Systems for Direct Recycling and Upcycling of Phosphate-based Cathode Active Materials,” which is incorporated by reference herein in its entirety.

### TECHNICAL FIELD

The present application generally relates to methods and systems for battery recycling, specifically in the direct recycling of phosphate-based cathode materials of batteries.

### BACKGROUND

Lithium ion batteries are widely used in portable electronic devices, electric vehicles, and home energy storage systems. Despite the increased use of lithium ion batteries, technologies to optimize recycling of these batteries have not kept pace.

### SUMMARY

Lithium ion batteries are one of the most common energy sources and are used in applications such as portable electronic devices such as cellphones and laptop computers, home energy storage systems, and electric vehicles (EV). Amongst these applications, the market for electric vehicles has experienced rapid growth in recent years. In 2022, about 60% of lithium, 30% of cobalt and 10% of nickel demand was for EV batteries. Just five years earlier, in 2017, these shares were around 15%, 10% and 2%, respectively. The rapid growth in EV deployment will inevitably be followed by a corresponding rise in the supply of end-of-life vehicles and their lithium ion batteries, which can present a serious waste-management challenge for recyclers at end-of-life (EOL).

EOL lithium ion batteries are expected to become important secondary sources for various materials used in the production of new batteries. Decreasing the cost of recycling and improving the recycling rate can thus significantly reduce the life cycle cost of lithium ion batteries, avoid material shortages, lessen the environmental impact of new material production, and provide low-cost active materials for the manufacturing of new lithium ion batteries. With the large increase in cell production expected in the next decade, primary scrap from production is another key source for global recycling efforts.

Exemplary cathode materials that are used in lithium ion batteries include lithium nickel manganese cobalt oxide (NMC), lithium (Li) transition metal oxides such as lithium cobalt oxide (LCO or LiCoO₂), lithium manganese oxide (LMO or LiMn₂O₄), lithium iron phosphate (LFP or LiFePO₄), and lithium nickel cobalt aluminum oxide (NCA or LiNiₓCo_{y}Al_{z}O₂). Currently, pyrometallurgy, hydrometallurgy, and conventional direct recycling are the three main pathways for recycling lithium ion batteries, and focus particularly on NMC batteries due to the higher value of the materials (e.g., nickel, cobalt, and copper) that are recoverable from these batteries. Although the current battery recycling processes are generally effective, they are very costly and typically only enable the recovery of specific metals, and in material forms that are of low value to battery manufacturers. Furthermore, different EVS on the market can have a variety of physical configurations, cell types, and cell chemistries, which can present challenges in terms of disassembly and applications for re-use.

Among the cathode materials, LFP batteries are increasingly used in widespread applications such as within the EV sector. Specifically, in 2023, over 40% lithium ion batteries in EVs were LFP batteries. LFP batteries have many advantages over NMCs, including an abundance of domestically available materials, lower cost, higher ignition point, longer lifespan, less degradation at higher temperatures compared to NMCs, and faster charging and discharging rates. However, it is very challenging for recycling companies who use conventional recycling methodologies to make the LFP recycling business sustainable due to the low value of LFP batteries which do not contain precious metals such as nickel and cobalt.

Recycling batteries is important for many reasons, including reducing waste, conserving natural resources, reducing the cost and energy use of manufacturing, securing the sustainable production of new lithium ion batteries, continuing to meet the demand for critical elements and materials such as lithium, cobalt, manganese, and graphite, and continuing to address issues related to the clean energy transition such as the demand for minerals needed for electric vehicles and renewable energy storage systems.

In view of the aforementioned reasons, there is a need for improved systems and methods for battery recycling. Specifically, decreasing the cost of recycling and improving the recycling rate can significantly reduce the life cycle cost of lithium ion batteries, avoid material shortages, lessen the environmental impact of new material production, and provide low-cost active materials for the manufacturing of new lithium ion batteries. With the large increase in cell production expected in the next decade, primary scrap from production is another key source for global recycling efforts. Specifically, for LFP battery materials, there is a need to develop low-cost recycling solutions to ensure the sustainability of the recycling business.

Some embodiments of the present disclosure are directed to improved methods and systems for direct recycling of lithium ion batteries. As used herein, direct recycling refers to the recovery, regeneration, and reuse of battery components directly without breaking down the chemical structure. Direct recycling is also referred to as direct cathode recycling and cathode-to-cathode recycling. Direct recycling is a promising approach for recycling lithium ion batteries because it can directly recycle and/or regenerate cathode and anode materials while keeping the cathode crystal structure intact (e.g., it does not destroy the chemical composition).

In particular, some embodiments disclosed herein pertain to direct recycling of spent phosphate-containing cathode materials, such as LFP (e.g., olivine LFP) or manganese doped LFP, where the spent phosphate-containing cathode materials are obtained from spent lithium ion batteries and processed and reused in new batteries (also referred to herein as “recycled cathode materials”). In some embodiments, the spent cathode materials are rejuvenated without a change in morphology or chemical composition. In some embodiments, the spent cathode materials are upgraded or upcycled through a physical change in morphology (e.g., shape or size) without a corresponding change in chemical composition. In some embodiments, the spent cathode materials are upgraded or upcycled through a physical change in morphology (e.g., shape or size) with a corresponding change in chemical composition. In some embodiments, the spent cathode materials are upgraded or upcycled through a change in particle crystallinity (e.g., from polycrystallinity to single crystallinity, or from single crystallinity to polycrystallinity). In some embodiments, the recycled cathode material has the same stoichiometry as the spent cathode material. In some embodiments, the spent cathode material is upgraded or upcycled by chemically changing its composition (or stoichiometry) from an initial chemical composition to an upcycled chemical composition. In some embodiments, the spent cathode material is upgraded or upcycled by re-lithiating the spent cathode material to increase a current content of lithium in the spent cathode material.

In accordance with some embodiments, the direct recycling techniques disclosed herein advantageously distinguish over current processes for commercially recycling lithium ion batteries. Specifically, compared to pyrometallurgy and hydrometallurgy approaches, the direct recycling techniques disclosed herein use less energy and less chemicals and incur lower costs. The direct recycling techniques disclosed herein also provide a lower cost solution compared to current direct recycling technologies. More importantly, the direct recycling approaches disclosed herein make recycling LFP batteries economically feasible and viable.

Some embodiments of the present disclosure include obtaining spent phosphate-containing cathode active materials (CAM), such as spent LFP or spent manganese-doped LFP (LMFP). In some embodiments, the spent phosphate-containing CAM that are obtained are attached on current collectors (e.g., aluminum foil). Furthermore, because the production of LFP cathodes routinely include the formation of a carbon coating on their outer surfaces (to increase the electrical conductivity of LFPs), in some embodiments the spent phosphate-containing CAM that are obtained can contain carbon coatings on the surfaces. Some embodiments of the present disclosure subject the spent phosphate-containing CAM to a thermal treatment in a carbon dioxide (CO₂) gas environment to remove most if not all of the carbon, thereby obtaining bare LFP or LMFP grains. In some embodiments, thermally treating the carbon-coated spent phosphate-containing CAM in CO₂ generates a chemical reaction (e.g., Boudouard reaction) where carbon from the carbon coatings of the spent phosphate-containing CAM react with the CO₂ gas to form carbon monoxide gas (which is removed) and bare LFP or LMFP grains. As disclosed, in some embodiments, after the thermal treatment process, the bare LFP or LMFP grains are subject to a rejuvenation process in which they are then coated (e.g., re-coated) with a carbon coating. In some embodiments, the rejuvenation process includes varying one or both of a morphology or chemical composition of the spent LFP/LMFP. In some embodiments, the rejuvenation process preserves one or both of the morphology or chemical composition of the spent LFP/LMFP.

In accordance with some embodiments, a method for direct recycling of cathode materials includes obtaining spent phosphate-containing cathode active materials (CAM) (e.g., LFP or LMFP). The method includes purifying the spent phosphate-containing CAM to obtain purified phosphate-containing CAM. The method includes regenerating the purified phosphate-containing CAM to obtain regenerated phosphate-containing CAM.

In some embodiments, the spent phosphate-containing CAM include a carbon coating. Purifying the spent phosphate-containing CAM includes substantially removing the carbon coating from at least a portion of the spent phosphate-containing CAM. In some embodiments, purifying the spent phosphate-containing CAM includes chemically reacting the spent phosphate-containing CAM in a non-oxidizing gaseous environment to substantially remove the coated carbon from the at least a portion of the spent phosphate-containing CAM.

In some embodiments, chemically reacting the spent phosphate-containing CAM includes applying a gas plasma treatment to the spent phosphate-containing CAM at a temperature of about 20° C. to 300° C. In some embodiments, chemically reacting the spent phosphate-containing CAM includes applying a heat treatment to the spent phosphate-containing CAM at a temperature of about 700° C. to 1000° C. In some embodiments, the non-oxidizing gaseous environment comprises a carbon dioxide (CO₂) environment having a CO₂ concentration of at least 95 atomic %.

In some embodiments, regenerating the purified phosphate-containing CAM includes maintaining (e.g., preserving, keeping unchanged) a morphology and chemical composition of the purified phosphate-containing CAM. In some embodiments, the regenerating includes forming a carbon coating on the at least some of the purified phosphate-containing CAM, the regenerating including: (i) wet milling the purified phosphate-containing CAM in an aqueous medium that includes one or more carbon-containing additives, to obtain an aqueous mixture of the purified phosphate-containing CAM and the one or more carbon-containing additives; (ii) spray drying the aqueous mixture to obtain clusters of phosphate-containing CAM; (iii) calcining the clusters of phosphate-containing CAM in a nitrogen gas environment to obtain dispersed particles of carbon-coated phosphate-containing CAM; and (iv) optionally, after the calcining, jet milling the dispersed particles to obtain the regenerated phosphate-containing CAM.

In some embodiments, regenerating the purified phosphate-containing CAM includes changing a morphology of the purified phosphate-containing CAM while preserving a chemical composition of the purified phosphate-containing CAM. In some embodiments, the regenerating includes forming a carbon coating on the purified phosphate-containing CAM, including: (i) wet milling the purified phosphate-containing CAM in an aqueous medium that includes one or more carbon-containing additives, to obtain an aqueous mixture of the purified phosphate-containing CAM and the one or more carbon-containing additives; (ii) spray drying the aqueous mixture to obtain clusters of phosphate-containing CAM; and (iii) calcining the clusters of phosphate-containing CAM to obtain dispersed particles of carbon-coated phosphate-containing CAM. In some embodiments, the forming the carbon coating includes, prior to the wet milling, subjecting the purified phosphate-containing CAM to an initial calcination (e.g., sintering) process. In some embodiments, the forming the carbon coating includes, after calcining the clusters of phosphate-containing CAM to obtain the carbon-coated dispersed particles of phosphate-containing CAM, jet milling the dispersed particles to obtain the regenerated carbon-coated, phosphate-containing CAM.

In some embodiments, regenerating the purified phosphate-containing CAM includes changing a chemical composition of the purified phosphate-containing CAM while preserving a morphology of the purified phosphate-containing CAM. In some embodiments, regenerating the purified phosphate-containing CAM includes forming (e.g., applying) a carbon coating on the at least some of the purified phosphate-containing CAM, including: (i) wet milling the purified phosphate-containing CAM in an aqueous medium that includes one or more carbon-containing additives, to obtain an aqueous mixture of the purified phosphate-containing CAM and the one or more carbon-containing additives; (ii) spray drying the aqueous mixture to obtain clusters of phosphate-containing CAM; and (iii) calcining the clusters of phosphate-containing CAM in a gaseous environment to obtain dispersed particles of carbon-coated phosphate-containing CAM. In some embodiments, the method includes adding MnPO4 and one or more of Li2CO3 or LiOH, MnPO4 and one or more of Na2CO3 or NaOH during the wet milling.

In some embodiments, regenerating the purified phosphate-containing CAM includes changing both a chemical composition and a morphology of the purified phosphate-containing CAM. In some embodiments, the regenerating includes forming (e.g., applying) a carbon coating on the purified phosphate-containing CAM, including (i) wet milling the purified phosphate-containing CAM in a first aqueous medium that includes one or more first additives to obtain a first aqueous mixture; (ii) subjecting the first aqueous mixture to a first calcination process, to obtain modified phosphate-containing CAM; (iii) wet milling the modified phosphate-containing CAM in a second aqueous medium that includes one or more carbon-containing additives to obtain a second aqueous mixture; (iv) spray drying the second aqueous mixture to obtain clusters of phosphate-containing CAM; and (v) subjecting the clusters of phosphate-containing CAM to a second calcination process to obtain dispersed particles of carbon-coated phosphate-containing CAM.

In another aspect, a system for direct recycling of batteries includes processing circuitry and memory, The memory stores instructions that are configured to be executed by the processing circuitry. The instructions, when executed by the processing circuitry, cause the system to perform any of the methods disclosed herein.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

### BRIEF DESCRIPTION OF THE DRAWINGS

The accompanying drawings, which are included to provide a further understanding of the embodiments, are incorporated herein, constitute a part of the specification, illustrate the described embodiments, and, together with the description, serve to explain the underlying principles.

FIG. 1A illustrates current approaches for recycling lithium ion batteries, in accordance with some embodiments.

FIG. 1B is a scanning electron microscope (SEM) image of an example particle (e.g., recovered metal materials 130 or recovered materials) generated from the recovery step in pyrometallurgy or the precipitation step in hydrometallurgy.

FIG. 1C is a SEM image of an example NMC particle that is generated from the cathode synthesis step in pyrometallurgy or hydrometallurgy, or from the relithiation or upcycling step in conventional direct recycling.

FIGS. 2A and 2B compares the current approaches for recycling lithium ion batteries, in accordance with some embodiments.

FIG. 2C is a chart illustrating the cost and environmental impacts to produce 1 kg of NMC 111.

FIG. 2D shows the economic performance resulting from the three battery recycling technologies for LFP and NMC batteries.

FIGS. 3A to 3D are representative scanning electron microscope (SEM) images of current LFP/LMFP materials, in accordance with some embodiments.

FIG. 4 illustrates a general strategy for directly recycling LFP/LMFP cathode materials, in accordance with some embodiments.

FIG. 5 illustrates a workflow for cathode-to-cathode direct recycling of phosphate-based cathode materials, in accordance with some embodiments.

FIG. 6 illustrates a process for forming a carbon coating on phosphate-containing cathode active materials (CAM) while preserving both the morphology and chemical composition of the phosphate-containing CAM, in accordance with some embodiments.

FIG. 7 illustrates a process for forming a carbon coating on phosphate-containing CAM, which changes a morphology while maintaining the chemical composition of the phosphate-containing CAM, in accordance with some embodiments.

FIG. 8 illustrates a process for forming a carbon coating on phosphate-containing CAM, which changes a chemical composition while maintaining the morphology of the phosphate-containing CAM, in accordance with some embodiments.

FIG. 9 illustrates a process for forming a carbon coating on phosphate-containing CAM, which changes the chemical composition and the morphology of the phosphate-containing CAM, in accordance with some embodiments.

FIG. 10 are experimental data that demonstrate the feasibility of the disclosed implementations, in accordance with some embodiments.

FIG. 11 illustrates an exemplary system for performing the direct recycling and upcycling processes disclosed herein, in accordance with some embodiments.

FIG. 12 provides a flowchart of an example method for direct recycling of cathode materials, in accordance with some embodiments.

FIGS. 13A and 13B collectively illustrates the characterization results of five working examples disclosed herein, in accordance with some embodiments.

Like reference numerals refer to corresponding parts throughout the several views of the drawings.

### DETAILED DESCRIPTION

Reference will now be made in detail to specific embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of the claims and the subject matter may be practiced without these specific details. For example, it will be apparent to one of ordinary skill in the art that the subject matter presented herein can be implemented on many types of electronic devices with digital video capabilities.

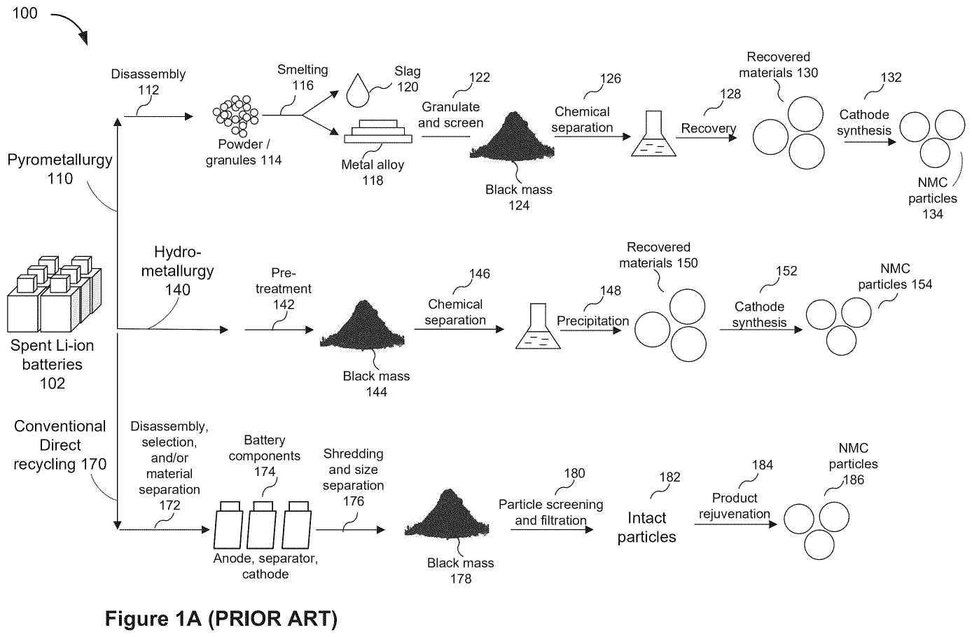

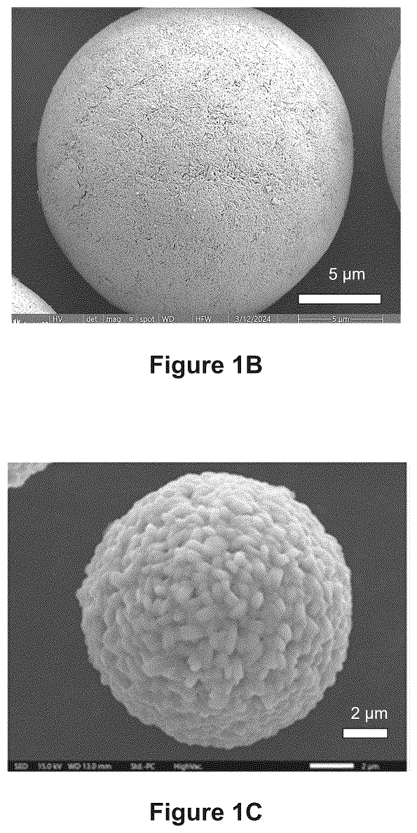

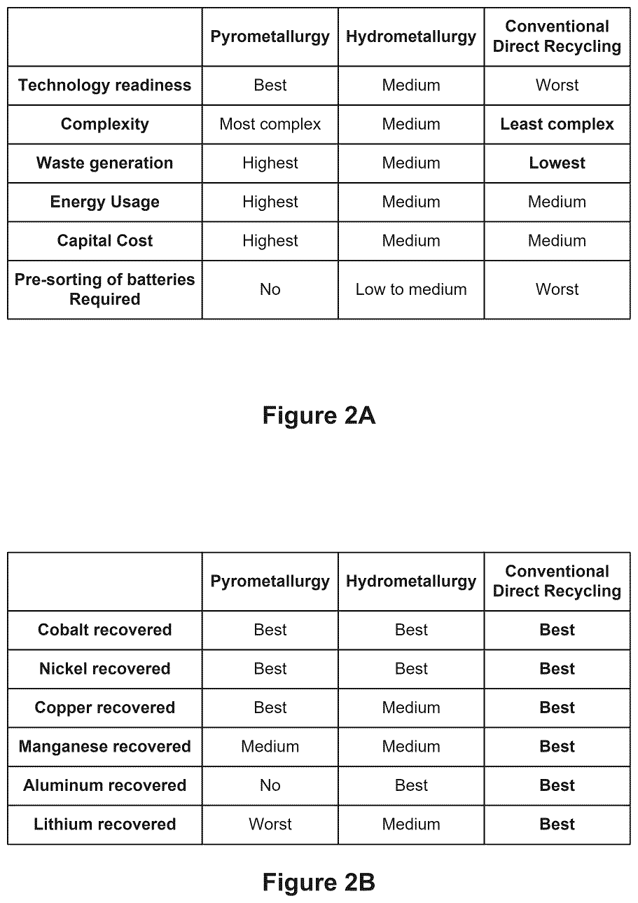

FIG. 1A illustrates current approaches 100 for recycling spent lithium ion batteries 102, in accordance with some embodiments. Pyrometallurgy 110, hydrometallurgy 140, and conventional direct recycling 170 are the three main pathways for recycling lithium ion batteries.

Pyrometallurgy 110 is a heat-based process that uses high heat to extract metals from spent batteries. Pyrometallurgy generally includes the step of disassembly 112, where the battery modules are deactivated, disassembled, and shredded to create a powder or granules 114. The powder or granules 114 are then subjected to a smelting process 116 where the powder or granules 114 are fed into a reactor that is heated to around 1500° C. The high heat melts the powder or granules 114 into slag 120 and a re-solidified a metal alloy 118. The metal alloy 118 is granulated and screened (122) to form black mass 124 (e.g., cathode active materials and graphite). The black mass 124 undergoes chemical separation processes 126, where it is chemically separated using acid treatment to dissolve the metal ions, followed by recovery processes 128, where the dissolved metal ions are recovered by precipitation or solvent extraction. FIG. 1B is a scanning electron microscope (SEM) image of an example particle (e.g., recovered metal materials 130) generated from the recovery processes 128. The diameter of the particle is about 12-15 μm. The recovered metal materials 130 are then reacted with other materials in the cathode synthesis step 132, to create new cathode materials (e.g., NMC particles 134) for batteries. FIG. 1C is a SEM image of an example NMC particle that is generated from the cathode synthesis step 132. The diameter of the particle is about 8-10 μm.

Hydrometallurgy 140 uses water-based solutions to dissolve and separate the metals from spent batteries. The spent batteries 102 first undergo a pretreatment process 142, which can include discharging and partly dismantling larger batteries, sorting the battery modules, physical separation, and mechanical treatment, including shredding, to produce a black mass 144. The black mass 144 is chemically separated (146) using techniques such as leaching, impurity removal, and purification. In the leaching step, the black mass 144 is leached with acids, bases, or reducing agents to dissolve the valuable metals. This is considered the most important step in recovering the metals. For impurity removal and purification, the metals are separated from impurities using chemical reactions. This can be done using hydrolytic precipitation, liquid-liquid reactions, or selective absorption. The metal ions are then recovered by precipitation 148. The SEM image in FIG. 1B shows an example particle (e.g., recovered metal materials 150) that is generated from the precipitation step 148. The recovered metal materials 150 are then reacted with other materials in the cathode synthesis step 152, to create new cathode materials (e.g., NMC particles 154) for batteries. The SEM image in FIG. 1C shows an example NMC particle 154 that is generated from the cathode synthesis 132.

In conventional direct recycling 170, the spent lithium ion batteries undergo one or more disassembly, selection and/or material separation processes 172, where the spent batteries are separated into battery components 174 (e.g., uncontaminated components) (e.g., anode, separator, and cathode). In some embodiments, the battery components 174 undergo shredding and size separation processes 176. After shredding, a feedstock of anode and cathode on their current collectors is generated. This feedstock contains the most valuable components in a lithium ion cell, including black mass 178 (e.g., active cathode materials and graphite), electrolyte, copper foils and aluminum foils. A particle screening and filtration step 180 is then performed, where cathode particles (e.g., polycrystalline particles) in the black mass 178 are screened to identify and select intact particles 182 whose physical structures are intact (i.e., not cracked) and/or have “better” states of health. The selected intact particles 182 then undergo a product rejuvenation process 184 in which their chemical compositions and lattice structures are restored by re-lithiation to generate NMC particles 186. In conventional direct recycling 170, particles whose physical structures are not intact (e.g., cracked particles) do not undergo the product rejuvenation step. Instead, they are re-routed for recycling using pyrometallurgy hydrometallurgy routes. The SEM image in FIG. 1C shows an example NMC particle that is generated from the product rejuvenation step 184.

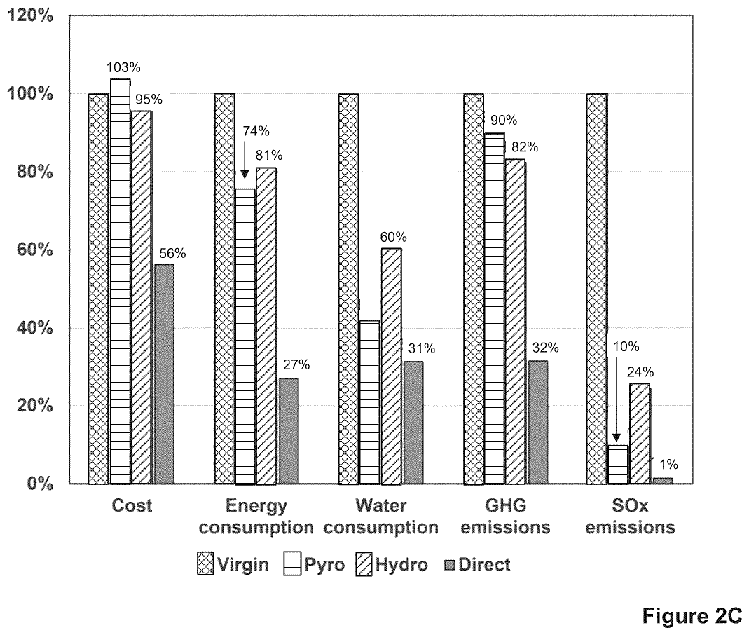

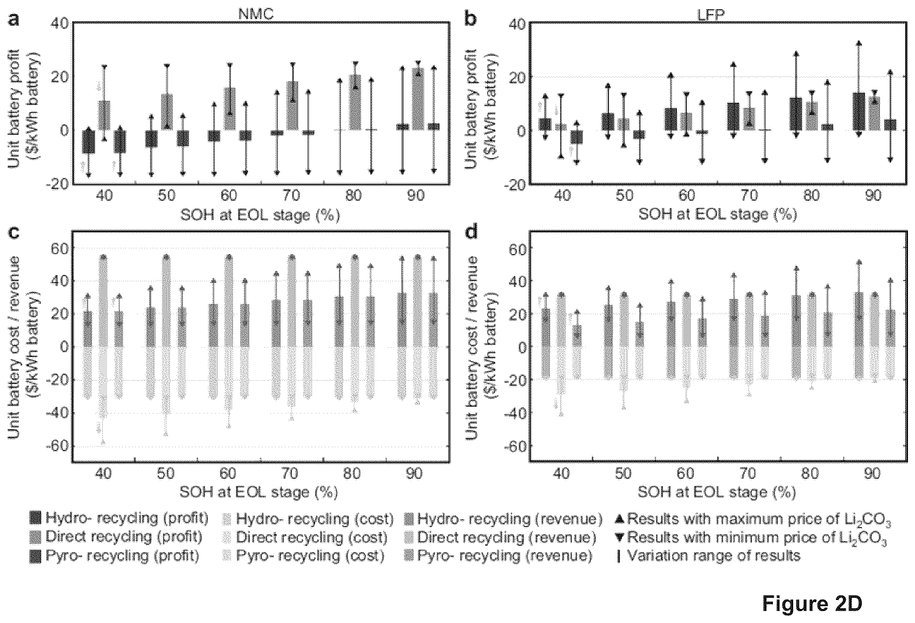

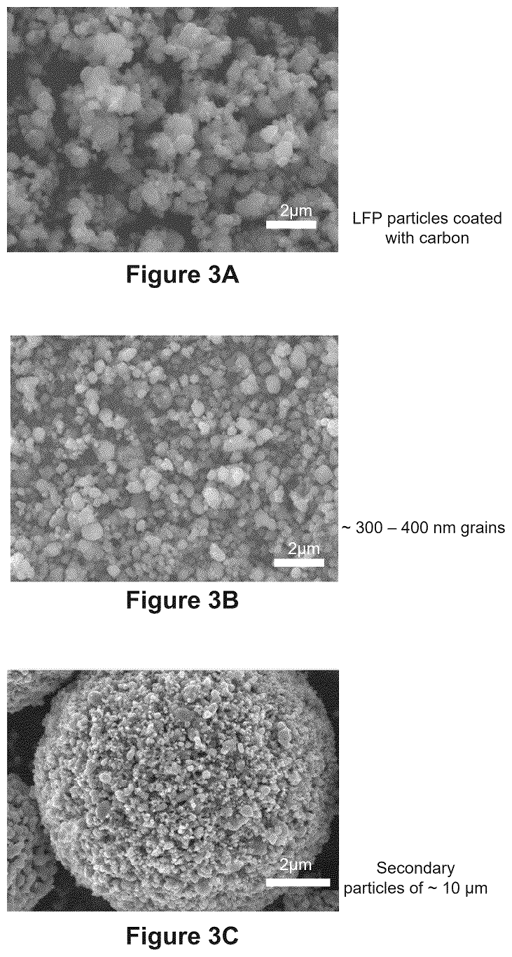

FIGS. 2A and 2B compares the current approaches for recycling lithium ion batteries, in accordance with some embodiments. These figures are adapted from Harper et al., “Recycling lithium-ion batteries from electric vehicles,” Nature 575, pp. 75-86 (2019), which is incorporated by reference herein in its entirety. FIG. 2A shows that of the three main pathways for recycling lithium ion batteries, conventional direct recycling is the least complex, has the lowest waste generation, and ranks best in terms of the quantity of recovered materials. However, it is also the least technology-ready and requires the most effort in terms of pre-sorting of batteries. Pyrometallurgy and hydrometallurgy produce the state-of-the-art recovered materials (e.g., 100% performance) but they are very costly. By comparison, conventional direct recycling may achieve ˜97% performance, but is cheaper and have easier processing steps compared to pyrometallurgy and hydrometallurgy.

FIG. 2B shows that of the three main pathways, conventional direct recycling ranks best in terms in recovering cobalt, nickel, copper, manganese, aluminum, and lithium.

FIG. 2C is a chart illustrating the cost and environmental impacts to produce 1 kg of NMC 111 from virgin raw materials and recycled pyrometallurgically, hydrometallurgically, and by conventional direct recycling, all alt large commercial scales (50,000 Tons/year). This figure is adapted from Gaines et al. “Direct Recycling R&D at the ReCell Center,” Recycling 6, 31 (18 pp.) (2021), which is incorporated by reference herein in its entirety. FIG. 2C illustrates that direct recycling is shown to have the lowest impacts in all categories.

FIG. 2D shows the economic performance resulting from the three battery recycling technologies for LFP and NMC batteries. This figure is reproduced from Ma et al., “Pathway decisions for reuse and recycling of retired lithium-ion batteries considering economic and environmental functions,” Nature Communications (2024) 15:7641, which is incorporated by reference herein in its entirety. Panels i to iv in FIG. 2C indicate that for all methods, the unit battery profit improves with increasing state of health (SOH) due to decreased active material loss, leading to either fewer inputs (direct recycling) or more valuable outputs (hydrometallurgical and pyrometallurgical recycling). For NMC batteries, direct recycling is the most profitable, as the SOH increases from 40% to 90%, due to its simplicity and the high value of the recovered NMC material. Profits range from $11.01 to $22.99/kWh battery for direct recycling, while pyrometallurgical and hydrometallurgical recycling yields range from minus $8.59 to positive $2.41 and minus $8.31.08 to positive $2.66/kWh battery, respectively. For LFP batteries, hydrometallurgical recycling is the most profitable, followed by direct and pyrometallurgical recycling. LFP recycling profits fluctuate less with SOH changes than those of the NMC counterpart, with both costs and revenues for LFP being smaller than those for NMC.

In view of the above, there is a need for improved systems and methods for direct recycling that would yield higher efficiency compared to conventional direct recycling approaches that exist today.

Some embodiments of the present disclosure are directed to cathode-to-cathode direct recycling and upcycling of phosphate cathode active materials, such as LFP and manganese doped LFP (LMFP). Current battery recycling industry does not recycle LFP or LMFP batteries because the profit margin is very low (e.g., close to zero or even negative), as evidenced in the study in FIG. 2D, but cathode-to-cathode direct recycling using the methods and systems disclosed herein can potentially makes the LFP recycling business profitable.

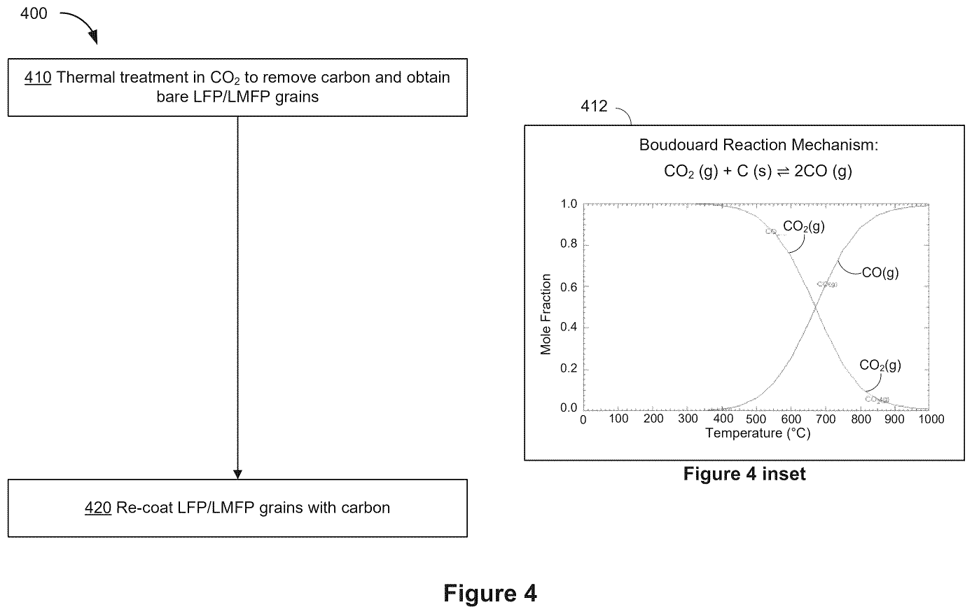

FIGS. 3A to 3D are representative scanning electron microscope (SEM) images of current LFP/LMFP materials, in accordance with some embodiments. The figures show that current LFP/LMFP materials are comprised of primary grains of about 200 nanometers (nm) to 4 micrometers (μm) in size. In some embodiments, the LFP/LMFP materials are made into secondary spheres of around 10 μm in size. LFP/LMFP particles have inherently poor electrical conductivity and cannot quickly transfer electrons during charging and discharging cycles, which is a major limitation when using this material as a cathode material in lithium ion batteries. Common strategies to improve the electrical conductivity performance of LFP materials include coating LFP particles with a layer of conductive carbon to provide pathways for electron transfer and decreasing the particle size of LFP particles to increase the surface area and potentially improve conductivity. Current LFP/LMFP particles are coated with around 1.2 to 2.0 weight % carbon and have a specific surface area (SSA) in the range of around 8-20 m²/g. A polymer binder such as polyvinylidene fluoride (PVDF), polytetrafluride (PTFE), or styrene-butadiene rubber (SBR) holds the LFP particles (e.g., carbon-coated LFP particles) together and adheres them to a current collector in lithium ion batteries, ensuring good electrical contact throughout the electrode.

There are several technical challenges to address when directly recycling LFP/LMFP cathodes. First, LFP/LMFP cathodes contain a polymer binder that has to be thermally decomposed in order to detach the LFP/LMFP particles from the current collector. Second, in order to upcycle the LFP/LMFP particles (e.g., change morphology and/or chemical composition of the particles), the conductive carbon coating has to be removed. Elaborating on the first technical challenge, current industry practices include heating used cathodes at around 500° C. in air to thermally decompose the polymer binder. While this process works well for NMC cathodes, it is not transferrable to LFP/LMFP cathodes because heating LFP/LMFP cathodes in air would cause the oxidation state of iron (Fe) in LFP (LiFePO₄) to change from Fe²⁺ to Fe³⁺, which destroys the destroys the chemistry of the LFP/LMFP. Furthermore, it is also not feasible to heat the LFP/LMFP cathodes in nitrogen (N₂) or argon (Ar) because this would cause the polymer binder to decompose into excessive coated carbon, which increases the SSA and decreases the particle packing density which is an important feature of LFP/LMFP cathodes.

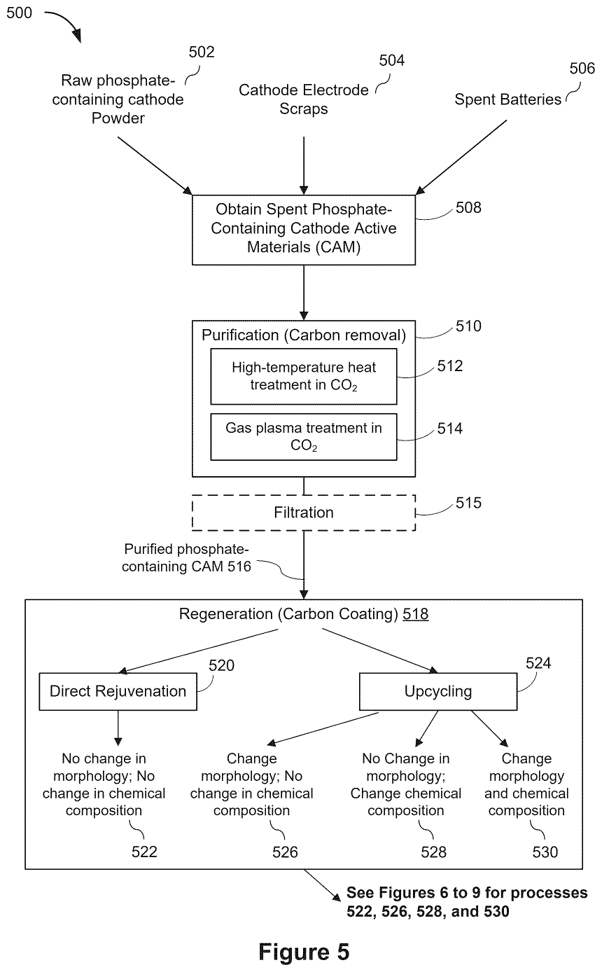

FIG. 4 illustrates a general strategy 400 of directly recycling LFP/LMFP cathode materials that addresses the aforementioned technical challenges, in accordance with some embodiments. The strategy 400 employs a two-step process whereby in the first step, the LFP/LMFP cathode materials (e.g., particles) are subjected to a thermal treatment (402) in CO₂ to remove carbon and obtain bare grains of LFP/LMFP. In some embodiments, the thermal treatment applies the Boudouard reaction mechanism whereby the carbon that is present in the LFP/LMFP cathode materials (e.g., conductive carbon layer and polymer binder) react with the CO₂ gas to form carbon monoxide gas (CO) that is removed as a byproduct. FIG. 4 inset is a graph 412 illustrating the Boudouard reaction mechanism. At around 700° C. (e.g., 702° C.), the Boudouard reaction significantly favors the production of CO due to the thermodynamic equilibrium shifting towards the formation of CO at this high temperature, making it a crucial point for utilizing the reaction in processes such as gasification, where CO₂ is converted to CO by reacting with carbon. the second step of the two-step process involves re-coating the bare grains of LFP/LMFP (420) with conductive carbon to restore their electrical conductivity performance. Although the strategy 400 identifies the cathode materials as LFP/LMFP, it would be apparent to one of ordinary skill int eh art that the strategy 400 is equally applicable to other phosphate-containing cathode materials such as sodium phosphate compounds.

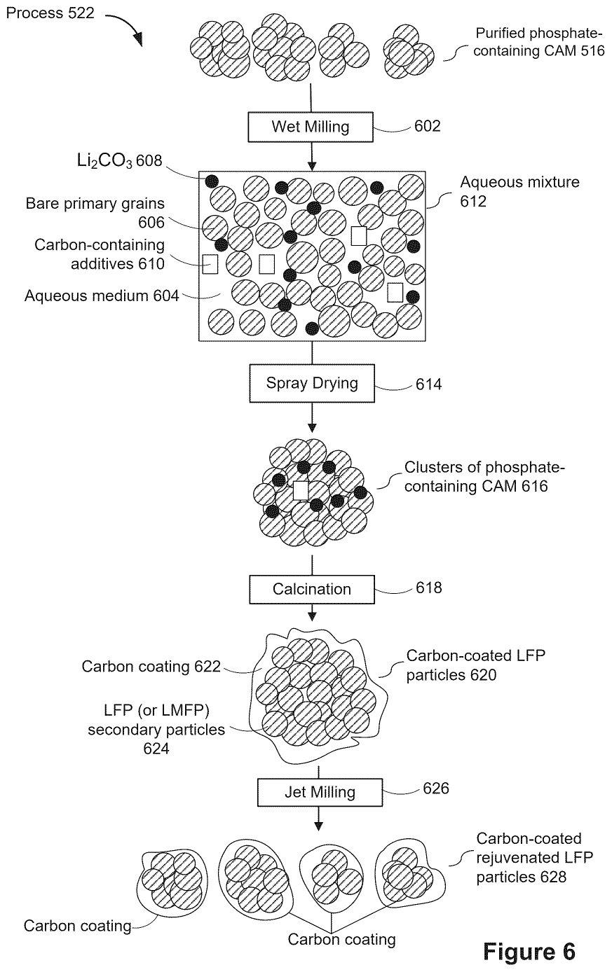

FIG. 5 illustrates a workflow 500 for cathode-to-cathode direct recycling of phosphate-based cathode materials, in accordance with some embodiments.

The workflow 500 includes obtaining spent phosphate-containing cathode active materials (CAM) 508. In some embodiments, the spent phosphate-containing CAM include lithium phosphate compounds such as LiFePO₄ (LFP) and LiMnₓFe₁₋ₓPO₄ (LMFP), wherein 0<x<1. In some embodiments, the spent phosphate-containing CAM include sodium phosphate compounds such as Na₄Fe₃(PO₄)₂P₂O₇ (NFP) and Na₄MnₓFe₃₋ₓ(PO₄)₂P₂O₇ (NMFP), wherein 0<x<1. In some embodiments, the spent phosphate-containing CAM comprises phosphate-containing CAM particles with dimensions on the order of nanometers, micrometers, millimeters, or centimeters, such as particles illustrated in FIGS. 3A to 3C.

In some embodiments, the spent phosphate-containing CAM 508 are obtained from sources such as raw phosphate-containing cathode powder 502, cathode electrode scraps 504 (e.g., aluminum scraps), and spent batteries 506.

In the case where the source of the spent phosphate-containing CAM 508 are spent batteries 506 (meaning that the spent phosphate-containing CAM are derived from spent cathode scraps of spent batteries), the spent cathode scraps can include a polymer binder that adheres the LFP/LMFP particles to a current collector. In this situation, the cathode-to-cathode direct recycling process involves crushing the spent batteries to obtain positive and negative electrode fragments, and subjecting the electrode fragments to a thermal powder detachment process (e.g., thermal de-pulverization or thermal de-powdering process) in which the polymer binder (e.g., PVDF, PTFE, or SBR) is thermally decomposed by heating the electrode fragments in an inert gas (e.g., nitrogen) at a temperature of about 350° C. to 500° C. The thermal de-powdering process generally does not exceed 500° C. in order to prevent aluminum in the spent batteries from melting. Furthermore, the thermal powder detachment process is performed in an inert gas environment to prevent iron (e.g., Fe²⁺) in the LFP cathode scraps from becoming oxidized (because once oxidized, the chemical composition of LFP changes and cannot undergo cathode-to-cathode recycling). In some embodiments, thermal powder detachment process breaks up the polymer chains in the polymer binder and converts the polymer chain into carbon residue that is adsorbed on the surface of the LFP to form carbon-excessive LFP. In some embodiments, the carbon-excessive LFP can have high specific surface areas and microporous, rough surfaces, making them difficult to compact during use. In some embodiments, the spent phosphate-containing CAM comprise carbon-excessive LFP/LMFP CAM that are obtained via a thermal de-pulverization process that occurs between 350° C.-500° C. in an inert gas (e.g., N₂) environment.

With continued reference to FIG. 5, the workflow 500 includes a purification process 510 that removes carbon (e.g., from the carbon coating or the polymer binder) from the spent phosphate-containing CAM to obtain purified phosphate-containing CAM 516. In accordance with some embodiments of the present disclosure, the purified phosphate-containing CAM 516 is an intermediate product that comprises bare grains of phosphate cathode materials such as LFP, LMFP, NFP, or NMFP, whereby the carbon that was originally present in the spent phosphate-containing CAM 508 are mostly (e.g., at least 80%, 90%, or 95% removed) or completely removed.

In some embodiments, the purification process 510 includes a high-temperature heat treatment process 512 that is performed at around 700° C. to 1000° C. in a CO2-containing, non-oxidizing gas environment. For example, the non-oxidizing gas environment may be pure CO₂ gas, or a mixture of CO₂ and N₂ gases. In some embodiments, the high-temperature heat treatment process 512 uses a roller hearth kiln (RHK), which is a continuous-firing industrial kiln that uses ceramic rollers, to transport the spent phosphate-containing CAM 508 and heat them in the non-oxidizing gas environment. The goals of the high-temperature heat treatment process 512 are to thermally decompose the polymer binder (e.g., PVDF, PTFE, or SBR) that may be present in the cathode electrode scraps 504 or spent batteries 506 and to remove the carbon coating that is present in the spent phosphate containing CAM by triggering the Boudouard reaction of CO₂ (g)+C(s) [symbol] 2CO (g) as illustrated in FIG. 4. The Boudouard reaction is a reversible reaction. Boudouard equilibrium in the conventional thermal reaction does not favor the CO disproportionation reaction until the temperature is increased to 702° C., when the entropic term, −TΔS, begins to dominate and the free energy becomes negative. The Boudouard reaction can occur both ways and depends on two factors: (i) thermal temperature and (ii) partial pressure of CO₂ and CO. To ensure that the reaction is in favor of consuming solid carbon, the reaction product of CO needs to be blown away to keep a high partial pressure of CO₂.

In some embodiments, the purification process 510 includes subjecting the spent phosphate-containing CAM to a plasma treatment 514 in a CO₂-containing, non-oxidizing gas environment (e.g., of pure CO₂ gas, or a mixture of CO₂ and N₂ gases) to obtain purified phosphate-containing CAM 516. In the plasma treatment 514, the spent phosphate-containing CAM are placed in a continuous plasma reactor with CO₂ gas flow to remove carbon from the CAM, and the carbon can be substantially removed in around 20-30 seconds. Compared with the conventional thermal reaction, microwave-driven reaction is a more energy-efficient way of converting carbon from the phosphate-containing CAM and CO₂ into CO. The microwave irradiation selectively heats the carbon in flowing CO₂ and can dramatically decrease the enthalpy of the reaction and shift the position of the equilibrium, so that the temperature at which CO becomes the major product drops significantly into a range of about 200° C. to 300° C.

In some instances where the spent phosphate-containing CAM are obtained in the form of raw phosphate-containing cathode powder 502, the raw phosphate-containing cathode powder 502 are subjected to the purification step 510 without additional processing. In some instances where the spent phosphate-containing CAM are obtained in the form of cathode electrode scraps 504 (e.g., aluminum scraps) or spent batteries 506, an additional filtration step 515 is performed after the heat or plasma treatment such as the heat- or plasma-treated materials are sieved to remove pieces of aluminum.

With continued reference to FIG. 5, the workflow 500 includes a regeneration process 518. As discussed above, the conductive carbon coating on the LFP/LMFP materials is essential for their electrical conductivity performance. Because the purified phosphate-containing CAM 516 contains very little of no carbon (the carbon having been removed in the purification process 510), the purified phosphate-containing CAM 516 need to be coated with carbon again to regain their electrical conductivity properties. The regeneration process 518 forms a carbon coating on at least some of the purified phosphate-containing CAM 516. In some embodiments, the regeneration process 518 comprises a direct rejuvenation process 520 (e.g., recycling) that does not alter the morphology or chemical composition of the purified phosphate-containing CAM 516 (process 522). In some embodiments, the regeneration process 518 comprises an upcycling process 524. In some embodiments, the upcycling process 524 includes changing a morphology of the purified phosphate-containing CAM 516 while maintaining (i.e., preserving, not changing) the chemical composition of the purified phosphate-containing CAM 516 (process 526). In some embodiments, the upcycling process 524 includes changing the chemical composition of the purified phosphate-containing CAM 516 while maintaining (i.e., preserving, not changing) the morphology of the purified phosphate-containing CAM 516 (process 528). In some embodiments, the upcycling process 524 includes changing both the morphology and the chemical composition of the purified phosphate-containing CAM 516 (process 530).

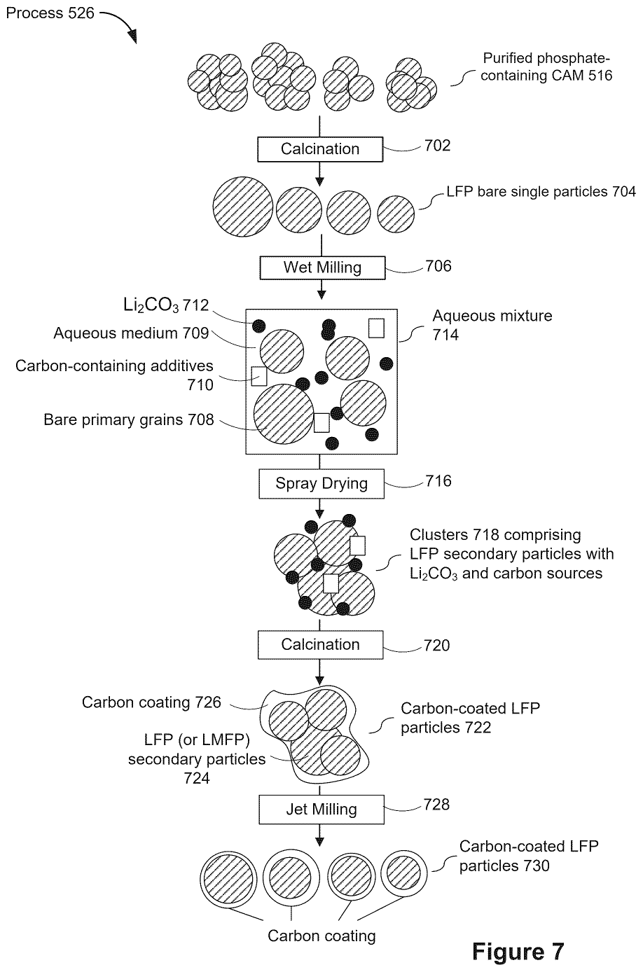

FIG. 6 illustrates a process 522 for forming a carbon coating on at least some of the purified phosphate-containing CAM 516 while preserving both the morphology and chemical composition of the purified phosphate-containing CAM 516, in accordance with some embodiments. In some embodiments, the purified phosphate-containing CAM 516 are bare LFP/LMFP grains (i.e., LFP/LMFP grains without carbon coating) such as primary grains with dimensions (e.g., diameters) around 300 nm to 400 m or secondary particles with a median diameter of around 1.0 μm to 1.5 μm. The purified phosphate-containing CAM 516 are subjected to a wet milling step 602, which causes the purified phosphate-containing CAM 516 to be deagglomerated into bare primary grains 606 suspended in an aqueous medium 604. In some embodiments, the aqueous medium 604 is mostly water (e.g., at least 60%, 70%, 80% or 90% water). In some embodiments, the aqueous medium 604 is deionized (DI) water. Lithium carbonate (Li₂CO₃) 608 and one or more carbon-containing additives 610 are added to the aqueous medium 604 and mixed with the bare primary grains 606 to form an aqueous mixture 612. In some embodiments, the carbon-containing additives 610 include one or more of: fructose, sucrose, polyvinyl alcohol (PVA), (polyethylene glycol) PEG, polyvinylpyrrolidone (PVP), Polypyrene (PPY), Polyacrylic Acid (PAA), Poly (methyl methacrylate) (PMMA), multi-wall carbon nanotubes (MWCNT), single-wall carbon nanotubes (SWCNT), graphene oxide (GO) and reduced graphene oxide (rGO). In some embodiments, lithium hydroxide (LiOH) is also added. In some embodiments where the spent batteries are sodium ion batteries, sodium carbonate (Na₂CO₃) or sodium hydroxide (NaOH) is added to the aqueous medium 604 instead of Li₂CO₃ or LiOH. In some embodiments, the wet milling step 602 results in an aqueous mixture 612 of the bare primary grains 606, Li₂CO₃ 608 and carbon-containing additives 610. The aqueous mixture 612 undergoes a spray drying step 614, which produces clusters 616 of phosphate-containing CAM. The clusters 616 undergo a calcination process 618 in N₂ gas. The calcination process 618 forms carbon-coated LFP (or LMFP) particles 620 that include carbon coating 622 and LFP (or LMFP) secondary particles 624 with a median diameter of about 4.0 μm to 20.0 μm. In some embodiments, the carbon-coated LFP particles 620 are subjected to a jet milling step 626 and carbon-coated rejuvenated LFP particles 628 are formed. In some embodiments, the LFP particles of the carbon-coated rejuvenated LFP particles 628 have the same morphology (e.g., shape and/or size) and chemical composition as the starting purified phosphate-containing CAM 516.

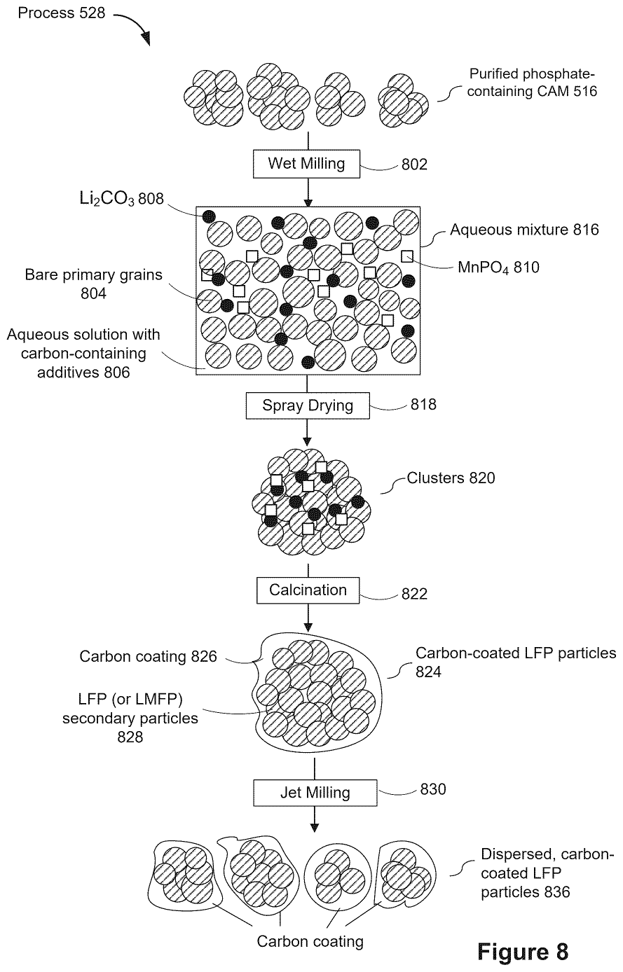

FIG. 7 illustrates a process 526 for forming a carbon coating on at least some of the purified phosphate-containing CAM 516, in accordance with some embodiments. In some embodiments, the process 526 changes a morphology of at least some of the purified phosphate-containing CAM 516 while maintaining (i.e., preserving, not changing) their chemical composition. The process 526 begins with purified phosphate-containing CAM 516. In some embodiments, the purified phosphate-containing CAM 516 undergo a calcination step 702 (e.g., sintering process). In some embodiments, the calcination step 702 occurs at around 700° C. to 750° C. in N₂ gas. The calcination step 702 causes the phosphate-containing CAM 516 to sinter to form LFP bare single particles 704 with a median diameter of around 1.0 μm to 1.5 μm.

In some embodiments, only purified phosphate-containing CAM 516 that are obtained via the gas plasma treatment process 514 need to undergo the calcination step 702. In some embodiments, purified phosphate-containing CAM 516 that are obtained via the high-temperature heat treatment process 512 undergo the calcination step 702. In some embodiments, purified phosphate-containing CAM 516 that are obtained via the high-temperature heat treatment process 512 need not undergo the calcination step 702. In some embodiments, high-temperature heat treatment process 512 is a multi-step heat treatment using different temperature settings, such that an initial heat treatment step is performed at a lower temperature (e.g., 700° C.) to remove the carbon coating from the spent phosphate-containing CAM, and a subsequent heat treatment step is performed at a higher temperature (e.g., 750° C. or more) to cause some of the purified phosphate-containing CAM to sinter to form grain sizes of around 1.5 μm or 2 μm or larger.

In some embodiments, the LFP bare single particles 704 undergo a wet milling step 706, which causes the LFP bare single particles 704 to be deagglomerated into bare primary grains 708 suspended in an aqueous medium 709 (e.g., deionized water). Li₂CO₃ 712 and one or more carbon-containing additives 710 are added to the aqueous medium 709 and mixed with the bare primary grains 708 to form an aqueous mixture 714. In some embodiments, the carbon-containing additives 710 include one or more of: fructose, sucrose, polyvinyl alcohol (PVA), (polyethylene glycol) PEG, polyvinylpyrrolidone (PVP), Polypyrene (PPY), Polyacrylic Acid (PAA), Poly (methyl methacrylate) (PMMA), multi-wall carbon nanotubes (MWCNT), single-wall carbon nanotubes (SWCNT), graphene oxide (GO) and reduced graphene oxide (rGO). In some embodiments, LiOH is also added. In some embodiments where the spent batteries are sodium ion batteries, Na₂CO₃ or NaOH is added to the aqueous medium 604 in place of the Li₂CO₃ or LiOH.

With continued reference to FIG. 7, in some embodiments, the aqueous mixture 714 undergoes a spray drying step 716 to form clusters 718 that include LFP secondary particles with Li₂CO₃ and carbon sources. In some embodiments, the clusters 718 undergo a calcination process 720 where the clusters 718 are calcined to obtain carbon-coated LFP particles 722 having a carbon coating 726 and LFP (or LMFP) secondary particles 724 whose mean diameters are about 4.0 μm to 20 μm. In some embodiments, the carbon-coated LFP particles 722 may comprise aggregates (e.g., chains) of particles. In some embodiments, a jet milling step 728 (e.g., deagglomeration process) is performed is performed to break the particle aggregates to form dispersed carbon-coated LFP particles 730.

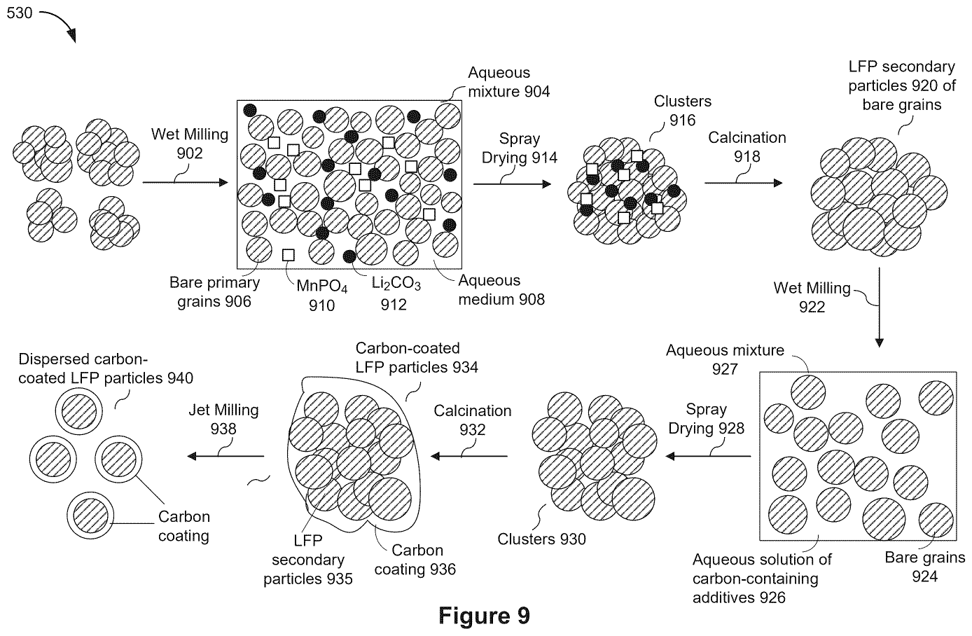

FIG. 8 illustrates a process 528 for forming a carbon coating on at least some of the purified phosphate-containing CAM 516, in accordance with some embodiments. In some embodiments, the process 528 changes a chemical composition of at least some of the purified phosphate-containing CAM 516 while maintaining (i.e., preserving, not changing) their morphology.

In some embodiments, in the process 528, the purified phosphate-containing CAM 516 undergo a wet milling step 802, which causes the purified phosphate-containing CAM 516 to be deagglomerated into bare primary grains 804 suspended in an aqueous solution 806 that comprises predominantly water (e.g., deionized water) and carbon-containing additives. In some embodiments, the carbon-containing additives include one or more of: fructose, sucrose, polyvinyl alcohol (PVA), (polyethylene glycol) PEG, polyvinylpyrrolidone (PVP), Polypyrene (PPY), Polyacrylic Acid (PAA), Poly (methyl methacrylate) (PMMA), multi-wall carbon nanotubes (MWCNT), single-wall carbon nanotubes (SWCNT), graphene oxide (GO) and reduced graphene oxide (rGO).

Li₂CO₃ 808 and manganese phosphate (MnPO₄) 810 are added to the aqueous solution 806. In some embodiments, the addition of Li₂CO₃ 808, MnPO₃ 810, and carbon additives is to facilitate the change in chemistry of the purified phosphate-containing CAM 516. In some embodiments, the bare primary grains 808, aqueous solution 806 comprising predominantly water and carbon-containing additives, Li₂CO₃ 808, and manganese phosphate (MnPO₄) 810 form an aqueous mixture 816. In some embodiments, the aquesous mixture 816 undergo a spray drying step 818 to obtain clusters 820 comprising LFP secondary particles with Li₂CO₃, MnPO₃, and carbon-containing additives. The clusters 820 are then calcined (822) to form carbon-coated LFP particles 824 comprising a carbon coating 826 and LFP (or LMFP) secondary particles 828. In some embodiments, a median diameter of the carbon-coated LFP particles 824 is around 4.0 μm to 20 μm. In some embodiments, the carbon-coated LFP particles 824 undergo a jet milling step 830 to form dispersed, carbon-coated LFP particles 836. In some embodiments, the LFP particles in the dispersed carbon-coated particles 836 have a different chemical composition compared to the purified phosphate-containing CAM 516. In some embodiments, the LFP particles in the dispersed carbon-coated particles 836 have the same morphology (e.g., shape and/or size) as the purified phosphate-containing CAM 516.

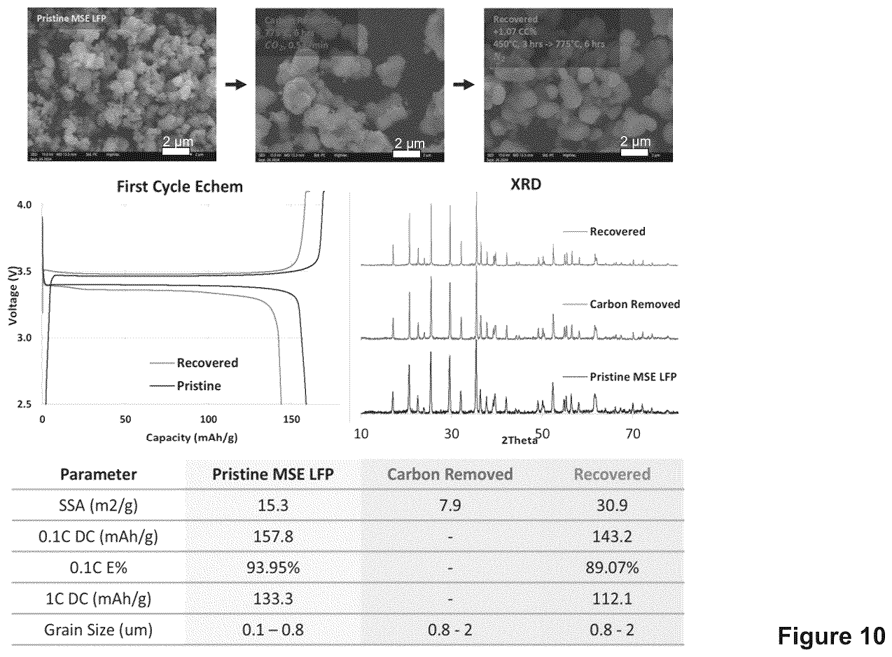

FIG. 9 illustrates a process 530 for forming a carbon coating on at least some of the purified phosphate-containing CAM 516, in accordance with some embodiments. The process 530 changes both the morphology and the chemical composition of at least some of the purified phosphate-containing CAM 516.

Referring to FIG. 9, in some embodiments, the purified phosphate-containing CAM 516 undergo a wet milling step 902, where the purified phosphate-containing CAM 516 are deagglomerated into bare primary grains 906 suspended in an aqueous medium 908 (e.g., deionized water). MnPO₄ 910 and Li₂CO₃ 912 are added to the aqueous medium 806. The bare primary grains 906, aqueous medium 908, MnPO₄ 910, and Li₂CO₃ 912 form an aqueous mixture 904, which undergoes a spray drying step to obtain clusters 916 comprising bare primary grains 906, MnPO₄ 910, and Li₂CO₃ 912. The clusters 916 undergo a calcination step 918 to obtain LFP secondary particles 920 of bare grains (i.e., no carbon coating). In some embodiments, the LFP secondary particles 920 of bare grains have a different chemical composition compared to the purified phosphate-containing CAM 516. In some embodiments, the LFP secondary particles 920 of bare grains have a morphology (e.g., shape and/or size) that is different from that of the purified phosphate-containing CAM 516

In some embodiments, the LFP secondary particles 920 of bare grains then undergo a wet milling step 922, in which the LFP secondary particles solution of bare grains are deagglomerated into bare grains 924 suspended in an aqueous solution 926 that includes water (e.g., DI water) and carbon-containing additives. In some embodiments, the carbon-containing additives include one or more of: fructose, sucrose, polyvinyl alcohol (PVA), (polyethylene glycol) PEG, polyvinylpyrrolidone (PVP), Polypyrene (PPY), Polyacrylic Acid (PAA), Poly (methyl methacrylate) (PMMA), multi-wall carbon nanotubes (MWCNT), single-wall carbon nanotubes (SWCNT), graphene oxide (GO) and reduced graphene oxide (rGO).

With continued reference to FIG. 9, in some embodiments, the bare grains 924 and aqueous solution 926 that includes water and carbon-containing additives form an aqueous mixture 927. In some embodiments, the aqueous mixture 927 undergo a spray drying step 928 to form clusters 930 that comprise bare grains and carbon-containing additives. In some embodiments, the clusters 930 undergo a calcination step (e.g., in N₂ gas) that causes the formation of carbon-coated LFP particles 934. The carbon-coated LFP particles 934 comprise LFP secondary particles 935 and carbon coating 936. In some embodiments, the carbon-coated LFP particles 934 are subjected to a jet milling step 938 to obtain dispersed carbon-coated LFP particles 940.

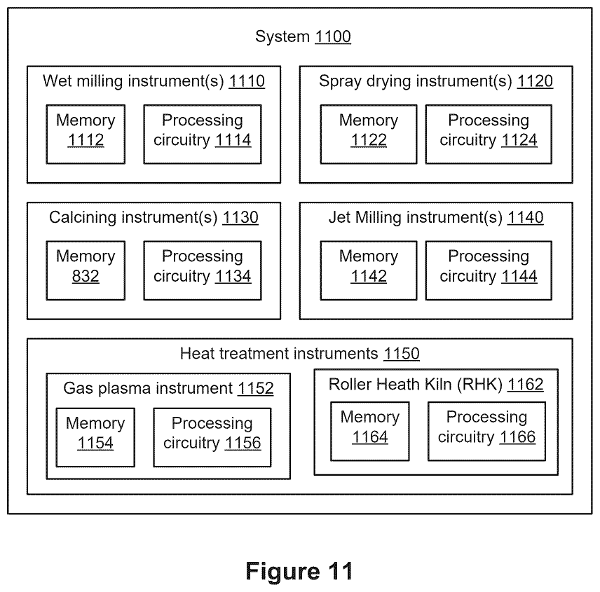

FIG. 10 are experimental data that demonstrate the feasibility of the disclosed implementations, in accordance with some embodiments. The experiment begins by heating pristine carbon-coated LFP particles at 775° C. in CO₂ gas environment at a gas flow rate of 0.5 liters/minute for about 6 hours to remove the carbon coating from the LFP particles. Then, sucrose (e.g., carbon-containing source) to the bare (e.g., uncoated) LFP particles and subjecting the mixture to heat treatment in N₂ gas for 3 hours at 450° C. followed by another 6 hours at 775° C. to re-form the carbon coating on the LFP particles. The top row are exemplary SEM images showing the pristine carbon-coated LFP particles (left), bare LFP particles after carbon removal (middle), and recovered carbon-coated LFP particles that have been re-coated with carbon. The data in the middle row shows, on the left, electrochemical data indicating that ˜95% of the capacity can be recovered. The data in the middle row shows, on the right, X-ray powder diffraction data (XRD) indicating that there is no change in the chemical composition of the LFP particles. The bottom row is a table showing the values of various parameters of the pristine carbon-coated LFP particles, carbon-removed LFP particles, and recovered LFP particles.

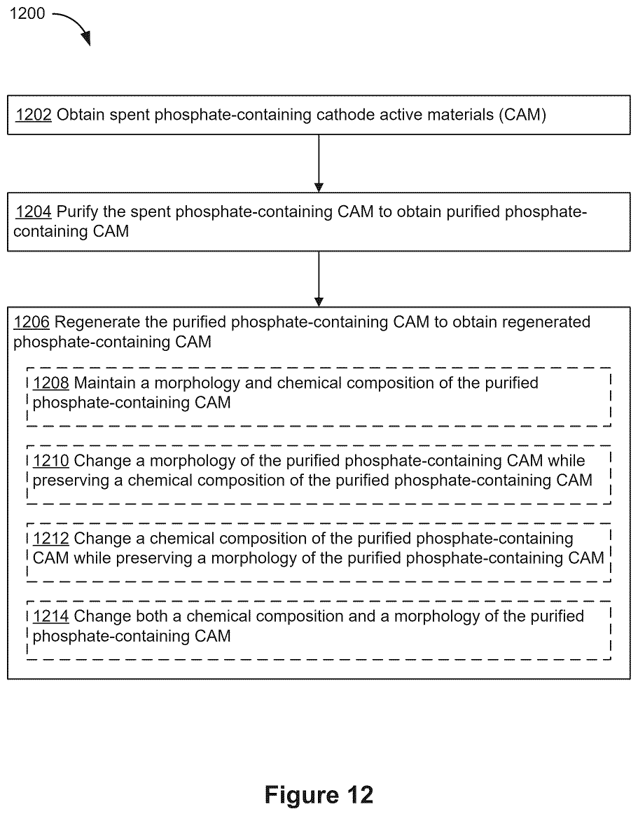

FIG. 11 illustrates an exemplary system 1100 for performing the direct recycling and/or upcycling processes disclosed herein, in accordance with some embodiments.

In some embodiments, the system 1100 includes one or more wet milling instruments 1110 for performing the wet milling steps disclosed herein (e.g., wet milling 602, 706, 802, 902, and 922). Examples of wet milling instruments include, and are not limited to, bead mills that use spherical balls or beads that tumble inside a rotating housing, colloid mills, wet ball mills that use a grinding medium and liquid for grinding materials, a multi-stage high shear dispersing machine for producing micro-emulsions, a cone mill for producing fine suspensions, a wet jet milling device that disperses, emulsifies, and pulverizes raw materials, and a high shear wet mill for submicron homogenizing and micronization. In some embodiments, the one or more wet milling instruments 1110 include memory 1112 and processing circuitry 1114 (e.g., a central processing unit (CPU) or a processor). The memory 1112 stores instructions that, when executed by the processing circuitry 1114, cause the wet milling instruments 1110 to perform any of the wet milling processes disclosed herein.

In some embodiments, the system 1100 includes one or more spray drying instruments 1120 for performing the spray drying steps disclosed herein (e.g., spray drying 614, 716, 818, 914, and 928). In some embodiments, one or more spray drying instruments 1120 are configured to produce dry granular powders from a slurry (e.g., a mixture of liquid solution and solid materials). In some embodiments, the spray drying instruments 1120 include temperature controllers, rotating atomizer wheels or nozzles to produce dry powders by drying the slurry using a heated air stream. In some embodiments, the one or more spray drying instruments 1120 include memory 1122 and processing circuitry 1124 (e.g., a central processing unit (CPU) or a processor). The memory 1122 stores instructions that, when executed by the processing circuitry 1124, cause the spray drying instruments 1120 to perform any of the spray drying processes disclosed herein.

In some embodiments, the system 1100 includes one or more calcining instruments 1130 for performing the calcination steps disclosed herein (e.g., calcination 618, 702, 822, 918, and 932). The calcining instruments 1130 can include one or more heating furnaces or ovens, one or more temperature controllers, and one or more gas sources and gas flow controllers. In some embodiments, the annealing instruments 1130 include memory 1132 and processing circuitry 1134 (e.g., a central processing unit (CPU) or a processor). The memory 1132 stores instructions that, when executed by the processing circuitry 1134, cause the calcining instruments 1130 to perform any of the calcination processes disclosed herein.

In some embodiments, the system 1100 includes one or more jet milling instruments 1140 for performing any of the jet milling steps disclosed herein (e.g., jet milling 626, 728, 830, and 938). The jet milling instruments 840 include memory 1142 and processing circuitry 1144 (e.g., a central processing unit (CPU) or a processor). The memory 1142 stores instructions that, when executed by the processing circuitry 1144, cause the jet milling instruments 1130 to perform any of the deagglomeration processes disclosed herein.

In some embodiments, the system 1100 includes one or more heat treatment instruments 1150 for performing the CO2 heat treatment processes (e.g., purification process 510, high-temperature heat treatment process 512, and plasma treatment 514) disclosed herein. In some embodiments, the heat treatment instruments 1150 include a gas plasma instrument 1152 for performing the gas plasma treatment process 514. The gas plasma instrument 1152 includes memory 1154 and processing circuitry 1156 (e.g., a central processing unit (CPU) or a processor). The memory 1154 stores instructions that, when executed by the processing circuitry 1156, cause the gas plasma instrument 1152 to perform the process 514.

In some embodiments, the heat treatment instruments 1150 include a roller heath kiln (RHK) 1162 for performing the high temperature heat treatment process 512. The RHK 1162 includes memory 1164 and processing circuitry 1166 (e.g., a central processing unit (CPU) or a processor). The memory 1164 stores instructions that, when executed by the processing circuitry 1166, cause the RHK 1162 to perform the process 512.

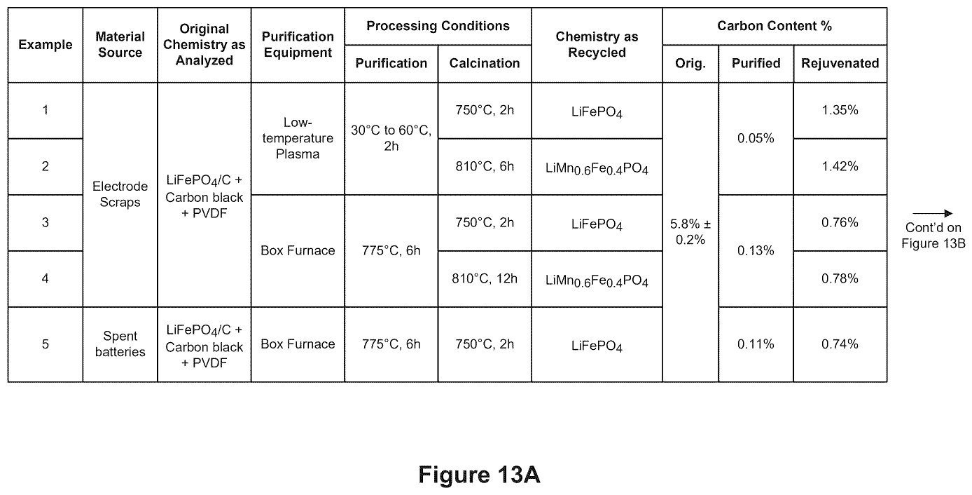

FIG. 12 provides a flowchart of an example method 1200 for direct recycling of cathode materials, in accordance with some embodiments.

The method includes obtaining (1202) spent phosphate-containing cathode active materials (CAM) (e.g.,) (e.g., spent phosphate-containing CAM 508 in FIG. 5). In some embodiments, the spent phosphate-containing CAM are obtained from spent lithium-ion batteries. In some embodiments, the spent phosphate-containing CAM are obtained from spent sodium-ion batteries. In some embodiments, the spent phosphate-containing CAM include at least one of lithium phosphate compounds and sodium phosphate compounds. In some embodiments, the lithium phosphate compounds include at least one of LiFePO₄ (LFP) and LiMnₓFe₁₋ₓPO₄ (LMFP), wherein 0<x<1. In some embodiments, the sodium phosphate compounds include at least one of: Na₄Fe₃(PO₄)₂P₂O₇ (NFPP) and Na₄MnₓFe₃₋ₓ(PO₄)₂P₂O₇ (NMFPP), wherein 0<x<1. In some embodiments, the spent phosphate-containing CAM comprises phosphate-containing CAM particles. In some embodiments, the spent phosphate-containing CAM are obtained from one or more of: unused phosphate-containing CAM, phosphate-containing CAM extracted from cathode electrode scraps, or phosphate-containing CAM extracted from cathode electrodes of aged batteries. In some embodiments, the spent phosphate-containing CAM are obtained from black mass, spent electrode materials, or spent batteries. In some embodiments, the spent phosphate-containing CAM are coated with carbon. In some embodiments, at least some of the spent phosphate-containing CAM are coated with carbon. In some embodiments, the carbon coating is a uniform coating. In some embodiments, the carbon coating is not uniform.

The method 1200 includes purifying (1204) (e.g., purification 510) the spent phosphate-containing CAM to obtain purified phosphate-containing CAM (e.g., purified phosphate-containing CAM 516). In some embodiments, purifying the spent phosphate-containing CAM includes substantially removing the coated carbon from at least a portion of the spent phosphate-containing CAM (e.g., removing at least 50%, 60%, 75%, 80%, 90%, 99% of the carbon coating, or completely removing the coated carbon). In some embodiments, the purified phosphate-containing CAM comprise bare grains of phosphate-containing materials that are not coated with carbon.

In some embodiments, purifying the spent phosphate-containing CAM includes chemically reacting the spent phosphate-containing CAM in a non-oxidizing gaseous environment to substantially remove the coated carbon from the at least a portion of the spent phosphate-containing CAM. For example, substantially removing the coated carbon can comprise removing at least 50%, at least 60%, at least 70%, at least 80%, at least 85%, at least 90%, or at least 95% of the coated carbon. In some embodiments, substantially removing the coated carbon can comprise removing all of the coated carbon (i.e., 100% removed). In some embodiments, chemically reacting the spent phosphate-containing CAM includes applying a gas plasma treatment (e.g., plasma treatment 514) to the spent phosphate-containing CAM at a temperature of about 20° C. to 300° C. (e.g., within ±1%, ±2%, ±3%, or ±5%). In some embodiments, chemically reacting the spent phosphate-containing CAM includes applying a heat treatment (e.g., high-temperature heat treatment process 512) to the spent phosphate-containing CAM at a temperature of about 700° C. to 1000° C. In some embodiments, the non-oxidizing gaseous environment comprises a CO₂ gas environment having a CO₂ concentration of at least 95 atomic percent.

In some embodiments, the spent phosphate-containing CAM includes scraps of aluminum (e.g., from the current collector). Purifying the spent phosphate-containing CAM includes sieving (e.g., filtering or separating) the purified phosphate-containing CAM after heat treating the spent phosphate-containing CAM) to remove the scraps of aluminum. This is illustrated in filtration step 515.

The method 1200 includes regenerating (1206) (e.g., regeneration 518) the purified phosphate-containing CAM to obtain regenerated phosphate-containing CAM.

In some embodiments, regenerating the purified phosphate-containing CAM includes maintaining (e.g., preserving, keep unchanged) a morphology and chemical composition of the purified phosphate-containing CAM (step 1208). This is also illustrated in direct rejuvenation step 520 and process 522 in FIGS. 5 and 6.

Referring to step 1208, in some embodiments, regenerating the purified phosphate-containing CAM includes forming (e.g., re-forming, applying, generating) a carbon coating on the at least some of the purified phosphate-containing CAM, as illustrated in process 522. In some embodiments, the regenerating includes wet milling (e.g., via wet milling step 602) the purified phosphate-containing CAM in an aqueous medium (e.g., aqueous medium 604) that includes one or more carbon-containing additives (carbon-containing additives 610), to obtain an aqueous mixture (e.g., aqueous mixture 612) of the purified phosphate-containing CAM and the one or more carbon-containing additives. In some embodiments, during the wet milling, one or more of: Li₂CO₃, LiOH, Na₂CO₃ or NaOH is added to the aqueous mixture. In some embodiments, the one or more carbon-containing additives include one or more of: fructose, sucrose, polyvinyl alcohol (PVA), (polyethylene glycol) PEG, polyvinylpyrrolidone (PVP), Polypyrene (PPY), Polyacrylic Acid (PAA), Poly (methyl methacrylate) (PMMA), multi-wall carbon nanotubes (MWCNT), single-wall carbon nanotubes (SWCNT), graphene oxide (GO), reduced graphene oxide (rGO), and their combinations thereof. In some embodiments, the regenerating includes spray drying (e.g., via spray drying step 614) the aqueous mixture to obtain clusters of phosphate-containing CAM (e.g., clusters 616). In some embodiments, the regenerating includes calcining (e.g., via calcination step 618) the clusters of phosphate-containing CAM in a nitrogen gas environment (e.g., the calcining causes the formation of a carbon coating around the clusters of phosphate-containing CAM) to obtain dispersed particles of carbon-coated phosphate-containing CAM (e.g., carbon-coated LFP particles 620). In some embodiments, the process 522 includes after the calcining, jet milling (e.g., jet milling step 626) the dispersed particles to obtain the regenerated phosphate-containing CAM (e.g., carbon-coated rejuvenated LFP particles 628).

In some embodiments, regenerating the purified phosphate-containing CAM includes changing a morphology of the purified phosphate-containing CAM while preserving a chemical composition of the purified phosphate-containing CAM (step 1210). This is also illustrated in upcycling 524 and process 526 in FIGS. 5 and 7.

Referring to step 1210, in some embodiments, regenerating the purified phosphate-containing CAM includes forming (e.g., re-forming, applying, generating) a carbon coating on the purified phosphate-containing CAM, as illustrated in process 526. In some embodiments, the regenerating optionally includes subjecting the purified phosphate-containing CAM 516 to an initial calcination step 702 (e.g., a sintering process) (e.g., at a temperature of about 700 to 750° C. or higher, in N₂ gas) to enlarge a size of the primary grains, which then undergo subsequent steps of wet milling, spay drying and calcination steps. In some embodiments, only those purified phosphate-containing CAM that are obtained via a gas plasma treatment process (e.g., gas plasma treatment 514) need to undergo the initial calcination step 702 are subjected to an initial calcination step 702. In some embodiments, purified phosphate-containing CAM that are obtained via the high-temperature heat treatment process 512 do not have to undergo the initial calcination step 702. In some embodiments, the high-temperature heat treatment process 512 is a multi-step process that applies different temperature settings. For example, the multi-step process can include an initial heat treatment that is performed at a lower temperature (e.g., around 700° C.) to remove the carbon coating from the spent phosphate-containing CAM, followed by a subsequent heat treatment that is performed at a higher temperature (e.g., 750° C. or higher) to cause some of the purified phosphate-containing CAM to sinter to form grain sizes of about 2 um or larger.

With continued reference to step 1210, and as further illustrated in process 526 in FIG. 7, in some embodiments, the regenerating includes after the optional calcination step 702, wet milling (e.g., via wet milling step 706) the purified phosphate-containing CAM in an aqueous medium (e.g., aqueous medium 709) that includes one or more carbon-containing additives (e.g., carbon-containing additives 710), to obtain an aqueous mixture (e.g., aqueous mixture 714) of the purified phosphate-containing CAM (e.g., bare primary grains 708) and the one or more carbon-containing additives. In some embodiments, during the wet milling, one or more of: Li₂CO₃ (e.g., Li₂CO₃ 712 LiOH, Na₂CO₃ or NaOH are added to the aqueous mixture. In some embodiments, the one or more carbon-containing additives include one or more of: fructose, sucrose, polyvinyl alcohol (PVA), (polyethylene glycol) PEG, polyvinylpyrrolidone (PVP), Polypyrene (PPY), Polyacrylic Acid (PAA), Poly (methyl methacrylate) (PMMA), multi-wall carbon nanotubes (MWCNT), single-wall carbon nanotubes (SWCNT), graphene oxide (GO), reduced graphene oxide (rGO), and their combinations thereof.

With continued reference to step 1210, and as further illustrated in process 526 in FIG. 7, in some embodiments, the regenerating includes spray drying (e.g., via spray drying step 716) the aqueous mixture to obtain clusters of phosphate-containing CAM (e.g., clusters 718); and calcining (e.g., second calcining, via calcination 720) the clusters of phosphate-containing CAM to obtain dispersed particles of carbon-coated phosphate-containing CAM (e.g., carbon-coated LFP particles 722). In some embodiments, the regenerating includes after the second calcination step 720, jet milling (e.g., via jet milling step 728) the dispersed particles to obtain the regenerated carbon-coated phosphate-containing CAM (e.g., carbon-coated LFP particles 730).

In some embodiments, regenerating the purified phosphate-containing CAM includes changing a chemical composition of the purified phosphate-containing CAM while preserving a morphology of the purified phosphate-containing CAM (step 1212). This is also illustrated in upcycling 524 and process 528 in FIGS. 5 and 8.

Referring to step 1212, and as illustrated in process 528 in FIG. 8, in some embodiments, regenerating the purified phosphate-containing CAM includes forming (e.g., re-forming, applying, generating) a carbon coating on the at least some of the purified phosphate-containing CAM, as illustrated in process 528. In some embodiments, the regenerating includes wet milling (e.g., via wet milling step 802) the purified phosphate-containing CAM 516 in an aqueous medium that includes one or more carbon-containing additives (e.g., aqueous solution 806), to obtain an aqueous mixture (e.g., aqueous mixture 816) of the purified phosphate-containing CAM (e.g., bare primary grains 804) and the one or more carbon-containing additives. In some embodiments, the one or more carbon-containing additives include one or more of: fructose, sucrose, polyvinyl alcohol (PVA), (polyethylene glycol) PEG, polyvinylpyrrolidone (PVP), Polypyrene (PPY), Polyacrylic Acid (PAA), Poly (methyl methacrylate) (PMMA), multi-wall carbon nanotubes (MWCNT), single-wall carbon nanotubes (SWCNT), graphene oxide (GO), reduced graphene oxide (rGO), and their combinations thereof. In some embodiments, MnPO₄ 810 and Li₂CO₃ 808 or LiOH are added during the wet milling to facilitate the compositional change of the purified phosphate-containing CAM. In some embodiments, the regenerating includes spray drying (e.g., via spray drying step 818) the aqueous mixture to obtain clusters of phosphate-containing CAM (e.g., clusters 820), and calcining (e.g., via calcination step 822) the clusters of phosphate-containing CAM in a gaseous environment (e.g., in N₂) to obtain dispersed particles of carbon-coated phosphate-containing CAM (e.g., carbon-coated LFP particles 824).

In some embodiments, regenerating the purified phosphate-containing CAM includes changing both a chemical composition and a morphology of the purified phosphate-containing CAM (step 1214). This is illustrated in upcycling 524 and process 530 in FIGS. 5 and 9.

Referring to step 1214, and as illustrated in process 530 in FIG. 9, in some embodiments, regenerating the purified phosphate-containing CAM includes forming (e.g., re-forming, applying, generating) a carbon coating on the purified phosphate-containing CAM, as illustrated in process 530. In some embodiments, the regenerating includes wet milling (e.g., via wet milling step 902) the purified phosphate-containing CAM in a first aqueous medium (e.g., aqueous medium 908) that includes one or more first additives to obtain a first aqueous mixture (e.g., aqueous mixture 904). In some embodiments, the one or more first additives include MnPO₄ (e.g., MnPO₄ 910) and Li₂CO₃ (e.g., Li₂CO₃ 912)/LiOH (e.g., in the case of lithium ion batteries). In some embodiments, the one or more first additives include MnPO₄ (e.g., MnPO₄ 910) and Na₂CO₃/NaOH (e.g., in the case of sodium ion batteries).

Referring to step 1214, and as illustrated in process 530 in FIG. 9, in some embodiments, the regenerating includes subjecting the first aqueous mixture (e.g., aqueous mixture 904) to a first calcination process (e.g., via calcination step 918), to obtain modified phosphate-containing CAM (e.g., LFP secondary particles 920 of bare grains). In some embodiments, the first calcination process changes a shape, size, and/or chemical composition of the at least some of the purified phosphate-containing CAM.

Referring to step 1214, and as illustrated in process 530 in FIG. 9, in some embodiments, the regenerating includes wet milling (e.g., via step 922) the modified phosphate-containing CAM (e.g., bare grains 924) in a second aqueous medium that includes one or more carbon-containing additives (e.g., aqueous solution 926) to obtain a second aqueous mixture (e.g., aqueous mixture 927). In some embodiments, the one or more carbon-containing additives include one or more of: fructose, sucrose, polyvinyl alcohol (PVA), (polyethylene glycol) PEG, polyvinylpyrrolidone (PVP), Polypyrene (PPY), Polyacrylic Acid (PAA), Poly (methyl methacrylate) (PMMA), multi-wall carbon nanotubes (MWCNT), single-wall carbon nanotubes (SWCNT), graphene oxide (GO), reduced graphene oxide (rGO), and their combinations thereof

Referring to step 1214, and as illustrated in process 530 in FIG. 9, in some embodiments, the regenerating includes spray drying the second aqueous mixture (e.g., via spray drying 928) to obtain clusters of phosphate-containing CAM (e.g., clusters 930); and subjecting the clusters of phosphate-containing CAM to a second calcination process (e.g., via calcination step 932) to obtain dispersed particles of phosphate-containing CAM (e.g., carbon-coated LFP particles 934).

Referring to step 1214, and as illustrated in process 530 in FIG. 9, in some embodiments, the regenerating includes after the second calcination process, jet milling (e.g., via jet milling step 938) the dispersed particles to obtain the regenerated phosphate-containing CAM (e.g., dispersed carbon-coated LFP particles 940).

### EXAMPLES

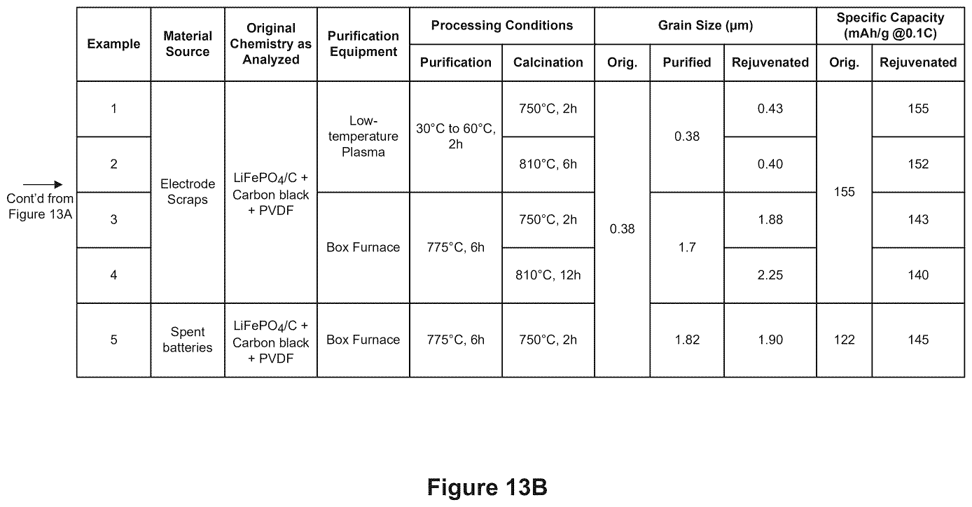

This section provides five working examples. Please refer to FIGS. 13A and 13B for the characterization results corresponding to the working examples.

### Example 1

### Direct Rejuvenation of LMFP Particles Obtained from Electrode Scraps without Changing Particle Morphology and Chemical Composition

Powder detachment: Shredded calendared LFP electrodes of manufacturing scrapes were heat-treated at 500° C. for 30 mins in a rotary kiln in pure N₂ (e.g., over 99% purity) gas. After the heat treatment, the polymer binder of LFP electrodes decomposed and the solid powders detached from the aluminum film. 200 grams of the black powder mixture comprising carbon black nanoparticles and carbon coated LFP/C were measured for subsequent purification.

Low-Temperature Plasma Purification (carbon removal): The 200 grams of black powder mixture was then rotated at 60 rpm in a batch rotary kiln in CO2 flow (purity 99.9%) with low-temperature plasma applied for 2 hours. The power of the plasma generator was set as 844 W and the frequency was set as 60 Hz. After this process, most of the carbon were removed, while the grain sizes remained unchanged.

Wet Grinding and Blending (e.g., wet milling): 100 grams of the materials were transferred from the purified LFP intermediates into a beads-mill tank with 6.2 grams sucrose and 250 ml water in a pin-type high-speed continuous beads mill. 80% volume of the beads mill was filled with 0.3 mm zirconium beads, and milling process was done at 2500 rpm for 20 min.

Spray drying, calcination, and jet-milling: The as-prepared slurry was then sprayed dried into micron-sized spherical polycrystalline particles and calcined in a box furnace under N₂ flow at 750° C. for 2 hours. The calcined materials comprised micron-sized polycrystalline particles, which were eventually deagglomerated through a jet-mill.

### Example 2

### Upcycling of LMFP Particles Obtained from Electrode Scraps by Changing Chemical Composition of Particles (from LFP to LMFP) without Changing Morphology

Powder detachment: Shredded calendared LFP electrodes of manufacturing scrapes were heat-treated at 500° C. for 30 mins in a rotary kiln in pure N₂ flow. After the heat treatment, the polymer binder of LFP electrodes decomposed and the solid powders detached from the aluminum film. 200 grams of the black powder mixture comprising carbon black nanoparticles and carbon coated LFP/C was measured out for subsequent purification.

Low-Temperature Plasma Purification (carbon removal): The 200 g black powder mixture was then rotated at 60 rpm in a batch rotary kiln in CO₂ flow (purity 99.9%) with low-Temp plasma applied for 2 hours. The power of the low-temperature plasma generator was set as 844 W, and the frequency was 60 Hz. After this process, most of the carbon were removed, while the grain sized remained unchanged.

Wet Grinding and Blending (e.g., wet milling): 40 grams of the materials were transferred from the purified LFP intermediates into a feeding tank of the same beads mill aforementioned. Furthermore, 43.7 g MnCO₃, 14.1 g Li₂CO₃, 43.7 g NH₄H₂PO₄, 6.2 g sucrose, and 350 ml water were added into the same tank and the mixture slurry were wet-grinded at 3000 rpm for 2 hours.

Spray drying, calcination, and jet-milling: The as-prepared slurry was then sprayed dried into micron-sized spherical polycrystalline particles, and calcined in a box furnace under N₂ flow at 810° C. for 6 hours. The calcined materials consisting of micron-sized polycrystalline particles were eventually deagglomerated through a jet-mill.

### Example 3

### Upcycling of LMFP Particles Obtained from Electrode Scraps by Changing Particle Morphology without Changing Chemical Composition

Powder detachment: Shredded calendared LFP electrodes of manufacturing scrapes were heat-treated at 500° C. for 30 mins in a rotary kiln in pure N₂ flow. After the heat-treatment, the polymer binder of LFP electrodes decomposed and the solid powders detached from the aluminum film. 200 grams of the black powder mixture consisting of carbon black nanoparticles and carbon coated LFP/C was measured out for purification.

High-temperature Thermal Purification (carbon removal): The 200 g black powder mixture was loaded into a graphite saggar, then heat-treated in a box furnace at 775° C. for 6 hours under CO2 flow (purity 99.9%). After this process, most of the carbon were removed, while the LFP grains sintered together and grew from a median size of ˜380 nm to a median size of ˜1.7 μm as observed.

Wet Grinding and Blending (e.g., wet milling): 100 g materials were transferred from the purified LFP intermediates into a feeding tank of the same beads mill mentioned above. 1.47 grams of niobium ammonium oxalate, 3.1 g sucrose and 250 ml water were added into the same tank and the mixture slurry were wet-grinded at 2000 rpm for 20 mins.

Spray drying, calcination, and jet-milling: The as-prepared slurry was then sprayed dried into micron-sized spherical polycrystalline particles, and calcined in a box furnace under N₂ gas flow at 750° C. for 2 hours. The calcined materials comprised micron-sized polycrystalline particles, which were eventually deagglomerated through a jet-mill.

### Example 4

### Upcycling of LMFP Particles Obtained from Electrode Scraps by Changing Both Particle Morphology and Chemical Composition (from LFP to LMFP)

Powder detachment: Shredded calendared LFP electrodes of manufacturing scrapes were heat-treated at 500° C. for 30 mins in a rotary kiln in pure N₂ flow. After the heat-treatment, the polymer binder of LFP electrodes decomposed and the solid powders detached from the aluminum film. 200 grams of the black powder mixture comprising carbon black nanoparticles and carbon coated LFP/C was measured out for purification.

High-Temp Thermal Purification (carbon removal): The 200 g black powder mixture was loaded into a graphite saggar, then heat-treated in a box furnace at 775° C. for 6 hours under CO₂ flow (purity 99.9%). After this process, most of the carbon were removed, while the LFP grains sintered together and grew from a median size of ˜380 nm to a median size of ˜1.7 μm as observed.

Wet Grinding and Blending (e.g., wet milling): 40 g materials were transferred from the purified LFP intermediates into a feeding tank of the same beads mill as described above. Additionally, 43.7 g MnCO₃, 14.1 g Li₂CO₃, 43.7 g NH₄H₂PO₄, 1.47 g niobium ammonium oxalate, 3.1 g sucrose and 350 ml water were added into the same tank and the mixture slurry were wet-grinded at 3000 rpm for 2 hours.

Spray drying, calcination, and jet-milling: The as-prepared slurry was then sprayed dried into micron-sized spherical polycrystalline particles, and calcined in a box furnace under N₂ flow at 810° C. for 12 hours. The calcined materials comprised micron-sized polycrystalline particles and were eventually deagglomerated through a jet-mill.

### Example 5

### Upcycling of LMFP Particles Obtained from Spent Batteries by Changing Particle Morphology without Changing Chemical Composition

Powder detachment: Shredded calendared LFP electrodes of spent LFP batteries were heat-treated at 500° C. for 30 mins in a rotary kiln in pure N₂ flow. After the heat-treatment, the polymer binder of LFP electrodes decomposed and the solid powders detached from the aluminum film. 200 grams of the black powder mixture consisting of carbon black nanoparticles and carbon coated LFP/C was measured out for purification. The LFP is determined to be ˜Li_{0.90}FePO₄, which is a typical lithium deficient structure in spent batteries.

High-Temp Thermal Purification (carbon removal): The 200 g black powder mixture was loaded into a graphite saggar, then heat-treated in a box furnace at 775° C. for 6 hours under CO₂ flow (purity 99.9%). After this process, most of the carbon were removed, while the LFP grains sintered together and grew from a median size of ˜380 nm to a median size of ˜1.82 μm as observed.

Wet Grinding and Blending (e.g., wet milling): 94 g materials were transferred from the purified LFP intermediates into a feeding tank of the same beads mill as described above. 15.0 g of Li₂CO₃, 1.47 g of niobium ammonium oxalate, 3.1 g of sucrose and 270 ml of water were added into the same tank and the mixture slurry were wet-grinded at 2000 rpm for 20 min.

Spray drying, calcination, and jet-milling: The as-prepared slurry was then sprayed dried into micron-sized spherical polycrystalline particles, and calcined in a box furnace under N₂ flow at 750° C. for 6 hours. The calcined materials comprised micron-sized polycrystalline particles, which were eventually deagglomerated through a jet-mill.

FIGS. 13A and 13B collectively illustrates the characterization results of Examples 1 to 5.

As used herein and unless otherwise indicated, “wt %” refers to a weight percent based on a total weight of a reference unless otherwise explained. “atomic %” refers to an atomic percent based on a total number of atoms of a reference unless otherwise explained.

When the term “about” is used, it is used to mean a certain effect or result can be obtained within a certain tolerance, and the skilled person knows how to obtain the tolerance. When the term “about” is used in describing a value or an end-point of a range, the disclosure should be understood to include the specific value or end-point referred to. In one aspect, the term “about” means plus or minus 20, 19, 18, 17, 16, 15, 14, 13, 12, 11, 10, 9, 8, 7, 6, 5, 4, 3, 2, or 1% of the numerical value of the number with which it is being used.

For convenience, many elements of the present embodiments are discussed separately, lists of options may be provided and numerical values may be in ranges; however, for the purposes of the present disclosure, that should not be considered as a limitation on the scope of the disclosure or support of the present disclosure for any claim of any combination of any such separate components, list items or ranges. Unless stated otherwise, each and every combination possible with the present disclosure should be considered as explicitly disclosed for all purposes.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

As used herein, the phrase “based on” does not mean “based only on,” unless expressly specified otherwise. In other words, the phrase “based on” describes both “based only on” and “based at least on.”

As used herein, the term “exemplary” means “serving as an example, instance, or illustration,” and does not necessarily indicate any preference or superiority of the example over any other configurations or implementations.

As used herein, the term “and/or” encompasses any combination of listed elements. For example, “A, B, and/or C” includes the following sets of elements: A only, B only, C only, A and B without C, A and C without B, B and C without A, and a combination of all three elements, A, B, and C.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

Some embodiments may be described based on the following clauses:

Clause 1. A method for direct recycling of cathode materials, comprising:
obtaining spent phosphate-containing cathode active materials (CAM);
purifying the spent phosphate-containing CAM to obtain purified phosphate-containing CAM; and
regenerating the purified phosphate-containing CAM to obtain regenerated phosphate-containing CAM.

Clause 2. The method of Clause 1, wherein:
the spent phosphate-containing CAM are coated with carbon; and
purifying the spent phosphate-containing CAM comprises substantially removing the coated carbon from at least a portion of the spent phosphate-containing CAM.

Clause 3. The method of Clause 2, wherein purifying the spent phosphate-containing CAM includes chemically reacting the spent phosphate-containing CAM in a non-oxidizing gaseous environment to substantially remove the coated carbon from the at least a portion of the spent phosphate-containing CAM.

Clause 4. The method of Clause 3, wherein chemically reacting the spent phosphate-containing CAM includes applying a gas plasma treatment to the spent phosphate-containing CAM at a temperature of about 20° C. to 300° C.

Clause 5. The method of Clause 3 or Clause 4, wherein chemically reacting the spent phosphate-containing CAM includes applying a heat treatment to the spent phosphate-containing CAM at a temperature of about 700° C. to 1000° C.

Clause 6. The method of any of Clauses 3-5, wherein the non-oxidizing gaseous environment comprises a carbon dioxide (a CO₂) environment having a CO₂ concentration of at least 95 atomic % and 100 atomic %.

Clause 7. The method of any of Clauses 2-6, wherein:
the spent phosphate-containing CAM includes scraps of aluminum; and
purifying the spent phosphate-containing CAM includes sieving the purified phosphate-containing CAM to remove the scraps of aluminum.

Clause 8. The method of any of Clauses 1-7, wherein the spent phosphate-containing CAM include at least one of lithium phosphate compounds and sodium phosphate compounds.

Clause 9. The method of Clause 8, wherein the lithium phosphate compounds include at least one of LiFePO₄ and LiMnₓFe₁₋ₓPO₄, wherein 0<x<1.

Clause 10. The method of Clause 8 or Clause 9, wherein the sodium phosphate compounds include at least one of: Na₄Fe₃(PO₄)₂P₂O₇ (NFPP) and Na₄MnₓFe₃₋ₓ(PO₄)₂P₂O₇ (NMFPP), wherein 0<x<1.

Clause 11. The method of any of Clauses 1-10, wherein the spent phosphate-containing CAM comprises phosphate-containing CAM particles.

Clause 12. The method of any of Clauses 1-11, wherein the spent phosphate-containing CAM are obtained from one or more of: unused phosphate-containing CAM, phosphate-containing CAM extracted from cathode electrode scraps, or phosphate-containing CAM extracted from cathode electrodes of aged batteries.

Clause 13. The method of any of Clauses 1-12, wherein regenerating the purified phosphate-containing CAM includes maintaining a morphology and chemical composition of the purified phosphate-containing CAM.

Clause 14. The method of Clause 13, wherein:
regenerating the purified phosphate-containing CAM includes forming a carbon coating on the at least some of the purified phosphate-containing CAM, the regenerating including:
wet milling the purified phosphate-containing CAM in an aqueous medium that includes one or more carbon-containing additives, to obtain an aqueous mixture of the purified phosphate-containing CAM and the one or more carbon-containing additives;
spray drying the aqueous mixture to obtain clusters of phosphate-containing CAM; and
calcining the clusters of phosphate-containing CAM in a nitrogen gas environment to obtain dispersed particles of carbon-coated phosphate-containing CAM.

Clause 15. The method of Clause 14, further comprising, after the calcining, jet milling the dispersed particles to obtain the regenerated phosphate-containing CAM.

Clause 16. The method of Clause 14 or Clause 15, further comprising: during the wet milling, adding one or more of: Li₂CO₃, LiOH, Na₂CO₃ or NaOH to the aqueous mixture.

Clause 17. The method of any of Clauses 14-16, wherein the one or more carbon-containing additives include one or more of: fructose, sucrose, polyvinyl alcohol (PVA), (polyethylene glycol) PEG, polyvinylpyrrolidone (PVP), Polypyrene (PPY), Polyacrylic Acid (PAA), Poly (methyl methacrylate) (PMMA), multi-wall carbon nanotubes (MWCNT), single-wall carbon nanotubes (SWCNT), graphene oxide (GO), reduced graphene oxide (rGO), and their combinations thereof.

Clause 18. The method of any of Clauses 1-12, wherein: regenerating the purified phosphate-containing CAM includes changing a morphology of the purified phosphate-containing CAM while preserving a chemical composition of the purified phosphate-containing CAM.

Clause 19. The method of Clause 18, wherein:
regenerating the purified phosphate-containing CAM includes forming a carbon coating on the purified phosphate-containing CAM, including:
   wet milling the purified phosphate-containing CAM in an aqueous medium that includes one or more carbon-containing additives, to obtain an aqueous mixture of the purified phosphate-containing CAM and the one or more carbon-containing additives;
   spray drying the aqueous mixture to obtain clusters of phosphate-containing CAM; and
   calcining the clusters of phosphate-containing CAM to obtain dispersed particles of carbon coated, phosphate-containing CAM.

Clause 20. The method of Clause 19, further comprising: prior to the wet milling, subjecting the purified phosphate-containing CAM to an initial calcination process.

Clause 21. The method of Clause 19 or Clause 20, further comprising: during the wet milling, adding one or more of: Li₂CO₃, LiOH, Na₂CO₃ or NaOH to the aqueous mixture.

Clause 22. The method of any of Clauses 19-21, further comprising: after calcining the clusters of phosphate-containing CAM to obtain the dispersed particles of carbon coated, phosphate-containing CAM, jet milling the dispersed particles to obtain the regenerated phosphate-containing CAM.

Clause 23. The method of any of Clauses 19-22, wherein the one or more carbon-containing additives include one or more of: fructose, sucrose, polyvinyl alcohol (PVA), (polyethylene glycol) PEG, polyvinylpyrrolidone (PVP), Polypyrene (PPY), Polyacrylic Acid (PAA), Poly (methyl methacrylate) (PMMA), multi-wall carbon nanotubes (MWCNT), single-wall carbon nanotubes (SWCNT), graphene oxide (GO), reduced graphene oxide (rGO), and their combinations thereof.

Clause 24. The method of any of Clauses 1-12, wherein regenerating the purified phosphate-containing CAM includes changing a chemical composition of the purified phosphate-containing CAM while preserving a morphology of the purified phosphate-containing CAM.

Clause 25. The method of Clause 24, wherein regenerating the purified phosphate-containing CAM includes forming a carbon coating on the at least some of the purified phosphate-containing CAM, including:
wet milling the purified phosphate-containing CAM in an aqueous medium that includes one or more carbon-containing additives, to obtain an aqueous mixture of the purified phosphate-containing CAM and the one or more carbon-containing additives;

spray drying the aqueous mixture to obtain clusters of phosphate-containing CAM; and

calcining the clusters of phosphate-containing CAM in a gaseous environment to obtain dispersed particles of carbon coated phosphate-containing CAM.

Clause 26. The method of Clause 25, further comprising: during the wet milling, adding MnPO₄ and one or more of Li₂CO₃ or LiOH.

Clause 27. The method of Clause 25 or Clause 26, further comprising: during the wet milling adding MnPO₄ and one or more of Na₂CO₃ or NaOH.

Clause 28. The method of any of Clauses 25-27, wherein the one or more carbon-containing additives include one or more of: fructose, sucrose, polyvinyl alcohol (PVA), (polyethylene glycol) PEG, polyvinylpyrrolidone (PVP), Polypyrene (PPY), Polyacrylic Acid (PAA), Poly (methyl methacrylate) (PMMA), multi-wall carbon nanotubes (MWCNT), single-wall carbon nanotubes (SWCNT), graphene oxide (GO), reduced graphene oxide (rGO), and their combinations thereof.

Clause 29. The method of any of Clauses 1-12, wherein regenerating the purified phosphate-containing CAM includes changing both a chemical composition and a morphology of the purified phosphate-containing CAM.

Clause 30. The method of Clause 29, wherein regenerating the purified
phosphate-containing CAM includes forming a carbon coating on the purified phosphate-containing CAM, including:
wet milling the purified phosphate-containing CAM in a first aqueous medium that includes one or more first additives to obtain a first aqueous mixture;
subjecting the first aqueous mixture to a first calcination process, to obtain modified phosphate-containing CAM;
wet milling the modified phosphate-containing CAM in a second aqueous medium that includes one or more carbon-containing additives to obtain a second aqueous mixture;
spray drying the second aqueous mixture to obtain clusters of phosphate-containing CAM; and
subjecting the clusters of phosphate-containing CAM to a second calcination process to obtain dispersed particles of carbon-coated phosphate-containing CAM.

Clause 31. The method of Clause 30, wherein the one or more first additives include MnPO₄ and Li₂CO₃/LiOH.

Clause 32. The method of Clause 30 or Clause 31, wherein the one or more first additives include MnPO₄ and Na₂CO₃/NaOH.

Clause 33. The method of any of Clauses 30-32, further comprising: after the second calcination process, jet milling the dispersed particles to obtain the regenerated phosphate-containing CAM.

Clause 34. The method of any of Clauses 30-33, wherein the one or more carbon-containing additives include one or more of: fructose, sucrose, polyvinyl alcohol (PVA), (polyethylene glycol) PEG, polyvinylpyrrolidone (PVP), Polypyrene (PPY), Polyacrylic Acid (PAA), Poly (methyl methacrylate) (PMMA), multi-wall carbon nanotubes (MWCNT), single-wall carbon nanotubes (SWCNT), graphene oxide (GO), reduced graphene oxide (rGO), and their combinations thereof.

Clause 35. The method of any of Clauses 1-34, wherein the spent phosphate-containing CAM are obtained from spent lithium-ion batteries.

Clause 36. The method of any of claims 1-34, wherein the spent phosphate-containing CAM are obtained from spent sodium-ion batteries.

Clause 37. A system for direct recycling of cathode materials, comprising:
processing circuitry; and
memory storing instructions that are configured to be executed by the processing circuitry, the instructions, when executed by the processing circuitry, cause the system to perform the method of any of claims 1-36.

Various embodiments described herein may be combined. In addition, one or more operations described with one method may be included in another method. For brevity, such details are not repeated herein.

What is claimed is:

1. A method for direct recycling of cathode materials, comprising:
obtaining spent phosphate-containing cathode active materials (CAM);
purifying the spent phosphate-containing CAM to obtain purified phosphate-containing CAM; and
regenerating the purified phosphate-containing CAM to obtain regenerated phosphate-containing CAM.

2. The method of claim 1, wherein:
the spent phosphate-containing CAM are coated with carbon; and
purifying the spent phosphate-containing CAM comprises substantially removing the coated carbon from at least a portion of the spent phosphate-containing CAM.

3. The method of claim 2, wherein:
purifying the spent phosphate-containing CAM includes chemically reacting the spent phosphate-containing CAM in a non-oxidizing gaseous environment to substantially remove the coated carbon from the at least a portion of the spent phosphate-containing CAM.

4. The method of claim 3, wherein chemically reacting the spent phosphate-containing CAM includes applying a gas plasma treatment to the spent phosphate-containing CAM at a temperature of about 20° C. to 300° C.

5. The method of claim 3, wherein chemically reacting the spent phosphate-containing CAM includes applying a heat treatment to the spent phosphate-containing CAM at a temperature of about 700° C. to 1000° C.

6. The method of claim 2, wherein:
the spent phosphate-containing CAM includes scraps of aluminum; and
purifying the spent phosphate-containing CAM includes sieving the purified phosphate-containing CAM to remove the scraps of aluminum.

7. The method of claim 1, wherein:
the spent phosphate-containing CAM include at least one of lithium phosphate compounds and sodium phosphate compounds;
the lithium phosphate compounds include at least one of LiFePO₄ and LiMnₓFe₁₋ₓPO₄, wherein 0<x<1; and
the sodium phosphate compounds include at least one of: Na₄Fe₃(PO4)₂P₂O₇ (NFPP) and Na₄MnₓFe₃₋ₓ(PO₄)₂P₂O₇ (NMFPP), wherein 0<x<1.

8. The method of claim 1, wherein:
the spent phosphate-containing CAM comprises phosphate-containing CAM particles; and
the spent phosphate-containing CAM are obtained from one or more of: unused phosphate-containing CAM, phosphate-containing CAM extracted from cathode electrode scraps, or phosphate-containing CAM extracted from cathode electrodes of aged batteries.

9. The method of claim 1, wherein regenerating the purified phosphate-containing CAM includes maintaining a morphology and chemical composition of the purified phosphate-containing CAM.

10. The method of claim 9, wherein:
regenerating the purified phosphate-containing CAM includes forming a carbon coating on the at least some of the purified phosphate-containing CAM, the regenerating including:
wet milling the purified phosphate-containing CAM in an aqueous medium that includes one or more carbon-containing additives, to obtain an aqueous mixture of the purified phosphate-containing CAM and the one or more carbon-containing additives;
spray drying the aqueous mixture to obtain clusters of phosphate-containing CAM; and
calcining the clusters of phosphate-containing CAM in a nitrogen gas environment to obtain dispersed particles of carbon-coated phosphate-containing CAM.

11. The method of claim 10, further comprising:
after the calcining, jet milling the dispersed particles to obtain the regenerated phosphate-containing CAM.

12. The method of claim 1, wherein regenerating the purified phosphate-containing CAM includes changing a morphology of the purified phosphate-containing CAM while preserving a chemical composition of the purified phosphate-containing CAM.

13. The method of claim 12, wherein:
regenerating the purified phosphate-containing CAM includes forming a carbon coating on the purified phosphate-containing CAM, including:
wet milling the purified phosphate-containing CAM in an aqueous medium that includes one or more carbon-containing additives, to obtain an aqueous mixture of the purified phosphate-containing CAM and the one or more carbon-containing additives;
spray drying the aqueous mixture to obtain clusters of phosphate-containing CAM; and
calcining the clusters of phosphate-containing CAM to obtain dispersed particles of carbon coated, phosphate-containing CAM.

14. The method of claim 13, further comprising:
prior to wet milling the purified phosphate-containing CAM, subjecting the purified phosphate-containing CAM to an initial calcination process; and
during the wet milling, adding one or more of: Li₂CO₃, LiOH, Na₂CO₃ or NaOH to the aqueous mixture.

15. The method of claim 1, wherein regenerating the purified phosphate-containing CAM includes changing a chemical composition of the purified phosphate-containing CAM while preserving a morphology of the purified phosphate-containing CAM.

16. The method of claim 15, wherein regenerating the purified phosphate-containing CAM includes forming a carbon coating on the at least some of the purified phosphate-containing CAM, including:
wet milling the purified phosphate-containing CAM in an aqueous medium that includes one or more carbon-containing additives, to obtain an aqueous mixture of the purified phosphate-containing CAM and the one or more carbon-containing additives;
spray drying the aqueous mixture to obtain clusters of phosphate-containing CAM; and
calcining the clusters of phosphate-containing CAM in a gaseous environment to obtain dispersed particles of carbon coated phosphate-containing CAM.

17. The method of claim 1, wherein regenerating the purified phosphate-containing CAM includes changing both a chemical composition and a morphology of the purified phosphate-containing CAM.

18. The method of claim 17, wherein regenerating the purified phosphate-containing CAM includes forming a carbon coating on the purified phosphate-containing CAM, including:
wet milling the purified phosphate-containing CAM in a first aqueous medium that includes one or more first additives to obtain a first aqueous mixture;
subjecting the first aqueous mixture to a first calcination process, to obtain modified phosphate-containing CAM;
wet milling the modified phosphate-containing CAM in a second aqueous medium that includes one or more carbon-containing additives to obtain a second aqueous mixture;
spray drying the second aqueous mixture to obtain clusters of phosphate-containing CAM; and
subjecting the clusters of phosphate-containing CAM to a second calcination process to obtain dispersed particles of carbon-coated phosphate-containing CAM.

19. The method of claim 1, wherein the spent phosphate-containing CAM are obtained from spent lithium-ion batteries or spent sodium-ion batteries.

20. A system for direct recycling of cathode materials, comprising:
processing circuitry; and
memory storing instructions that are configured to be executed by the processing circuitry, the instructions, when executed by the processing circuitry, cause the system to perform operations comprising:
obtaining spent phosphate-containing cathode active materials (CAM);
purifying the spent phosphate-containing CAM to obtain purified phosphate-containing CAM; and
regenerating the purified phosphate-containing CAM to obtain regenerated phosphate-containing CAM.
